(19) United States
(12) Patent Application Publication
(10) Pub. No.: US 2019/0274193 A1
(43) Pub. Date: Sep. 5, 2019

(54) INDUCTION HEATING APPARATUS, REPAIR METHOD AND VACUUM HOOD APPARATUS

(71) Applicant: Deutsches Zentrum fuer Luft- und Raumfahrt e.V., Koeln (DE)

(72) Inventors: Markus Kaden, Stuttgart (DE); Marvin Schneider, Herrenberg (DE)

(21) Appl. No.: 16/199,536

(22) Filed: Nov. 26, 2018

Related U.S. Application Data
(63) Continuation of application No. PCT/EP2017/062358, filed on May 23, 2017.

(30) Foreign Application Priority Data
May 31, 2016 (DE) 10 2016 209 487.4

(51) Int. Cl. H05B 6/10; H05B 6/14; H05B 6/44; B29C 73/12; B29C 35/08

(52) U.S. Cl. CPC H05B 6/105; H05B 6/14; H05B 6/44; B29C 2035/0811; B29C 35/0805; H05B 2206/022; B29C 73/12

(57) ABSTRACT

An induction heating apparatus is proposed, comprising at least one coil layer having a coil device and a carrier, on which carrier the coil device is arranged, wherein the at least one coil layer is of flexurally flexible configuration, wherein the at least one coil layer is embedded in the structural material of the vacuum hood and wherein the vacuum hood having the at least one coil layer is of flexurally flexible configuration.

This application is a continuation of international application number PCT/EP2017/062358 filed on May 23, 2017 and claims the benefit of German application No. 10 2016 209 487.4 filed on May 31, 2016, which are incorporated herein by reference in their entirety and for all purposes.

### BACKGROUND OF THE INVENTION

The invention relates to an induction heating apparatus, comprising at least one coil layer having a coil device and a carrier, on which carrier the coil device is arranged, wherein the at least one coil layer is of flexurally flexible configuration.

The invention further relates to a repair method using an induction heating apparatus in accordance with the invention, wherein the induction heating apparatus is applied to a repair region of a workpiece, a negative pressure region is created between the workpiece and the vacuum hood and a material is heated in the repair region, wherein the heating of the material is realized via a susceptor arranged in the repair region, which susceptor is inductively heated by way of the induction heating apparatus.

The invention further relates to a vacuum hood apparatus, comprising a vacuum hood, wherein the vacuum hood has an underside which, in operation of the vacuum hood apparatus, faces towards a workpiece, wherein the vacuum hood comprises a channel device comprising at least one feed channel and a channel structure having at least one channel at the underside, and wherein the channels of the channel structure are, at an opening thereof, open towards the underside and are operatively connected to the at least one feed channel for fluid communication therewith.

DE 20 2011 004 357 U1 discloses a vacuum hood apparatus comprising a vacuum hood for providing gas-tight covering during a pressing operation performed by applying a gas pressure to a layer of a curable composite substrate applied to a solid shaped body and including a fibre structure and a matrix of a curable viscous filling material incorporated in the fibre structure. The vacuum hood is made of an elastic plastics material, the temperature of which can be adjusted by way of an electrical heating device.

DE 20 2015 100 080 U1 discloses an induction heating apparatus, comprising a carrier and a coil device arranged on the carrier. The coil device comprises a plurality of spiral-shaped windings which are arranged in rows and columns, wherein the spiral-shaped windings are configured such that when an electrical current is passed through the spiral-shaped windings, a direction of current is at least approximately the same in adjacent peripheral winding sections of spiral-shaped windings adjacent in a row or column.

DE 10 2013 111 266 A1 discloses a coil device, comprising at least one current-carrying high-frequency Litz wire and a carrier for the at least one high-frequency Litz wire. The at least one carrier is a meshed net and the at least one high-frequency Litz wire is held via one or more holding threads which are in contact against the at least one high-frequency Litz wire and strands of the meshed net.

WO 96/39291 discloses a method for forming or consolidating organic matrix composite materials. The method provides for the composite material to be arranged between two susceptors, wherein the susceptors are heated inductively and the heat from the susceptors is transferred to the composite material. The heated composite material is then formed.

WO 2010/089479 A1 discloses a device for producing a workpiece from a fibre composite material, comprising an inductive flexible membrane and an electrically conductive rigid part. The inductive flexible membrane generates a magnetic field which creates eddy currents in the rigid part and the eddy currents generate a flow of heat. This flow of heat heats the workpiece by conduction of heat.

EP 2 575 410 A2 discloses an induction heating method, comprising selecting at least two induction coil circuits, wherein each induction coil circuit includes a susceptor having a Curie temperature. The induction coil circuits are coupled in parallel with each other and in series with an AC power supply unit. Energy is shunted away from the first induction coil circuit to the second induction coil circuit as soon as the susceptor of the first induction coil circuit reaches its Curie temperature.

U.S. Pat. No. 6,091,063 discloses a method for improving the thermal homogeneity of a workpiece in an induction heating process. The method comprises arranging the workpiece along the centerline of a solenoid induction coil so that the coil wraps around the workpiece along the length of the workpiece. Electrically nonconducting ferrite blocks are arranged at the ends of the coil to alter the magnetic flux from the coil in order to produce a more uniform energy density and improved thermal homogeneity within the workpiece.

DE 10 2012 107 820 A1 discloses a method for producing a fibre composite component part. According to the method, provision is made for placing a fibre preform in a mould tool and then sealing off the fibre preform in vacuum-tight relation by a vacuum film such that an injection region with the fibre preform is formed between the mould tool and the vacuum film. The injection region is evacuated by way of a pressure sink and is then injected with a matrix resin in order to infiltrate the fibre preform in the injection region with the matrix resin.

DE 10 2013 223 284 A1 discloses an apparatus for fabricating a fibre-reinforced plastic component part, the apparatus comprising a forming tool, in which a board-like and in particular textile fibre preform is hot-formable, in which electrically conductive reinforcing fibres are embedded in a heat-activatable binder, and an induction heater which comprises at least one inductor for creating a magnetic alternating field which induces electric currents in the electrically conductive reinforcing fibres of the fibre preform. The inductor is at least one sheet-like insert part separate from the forming tool, which insert part can be placed into the forming tool together with the fibre preform.

DE 10 2011 076 463 A1 discloses a repair method for a shaped part made of a plastics material, in which method a repair element formed from the plastic material is applied to a damaged area of the shaped part and is substance to substance bonded to the shaped part under the action of heat. The heat is created by way of a passive heating element made of an electrically conductive material by applying a magnetic alternating field to the heating element.

DE 10 2010 025 068 A discloses a mould tool for a manufacturing apparatus for manufacturing fibre-reinforced component parts by an injection process, wherein the mould tool comprises a mould surface for forming a surface of the fibre-reinforced component part, wherein the mould surface has a first partial area and a second partial area, and wherein the mould tool comprises an injection area for injecting a matrix material into fibre material located on the mould surface through the second partial area of the mould surface and an evacuation area for evacuating a mould volume bounded by the mould tool through the first partial area of the mould surface.

US 2012/0018089 A1 discloses a device for producing parts from a composite material, the device comprising a deformable membrane, a rigid portion and gas removal means for creating a vacuum between the membrane and the rigid portion. The deformable membrane comprises at least one inductor which is connected to a power supply unit. The rigid portion is at least partially electrically conductive.

### SUMMARY OF THE INVENTION

In accordance with an exemplary embodiment of the invention, an induction heating apparatus is provided with which homogeneous heating, over an area, of workpieces having different geometries can be achieved with a compact construction.

In accordance with an exemplary embodiment of the invention, the induction heating apparatus comprises:

at least one coil layer having a coil device and a carrier, on which carrier the coil device is arranged;

wherein the at least one coil layer is of flexurally flexible configuration;

wherein the at least one coil layer is embedded in the structural material of a vacuum hood; and

wherein the vacuum hood having the at least one coil layer is of flexurally flexible configuration.

By embedding the coil layer in the structural material of the vacuum hood, the vacuum hood having the coil layer forms an integral component. Said integral component is of flexurally flexible configuration as a whole. A negative pressure region can be created between the vacuum hood and a workpiece by applying a negative pressure. By the pressure difference between an outside space and the negative pressure region the vacuum hood is urged against the workpiece and an approximately constant distance can be established between the coil layer of the vacuum hood and the workpiece.

The negative pressure region is enclosed by edge regions of the vacuum hood in gas-tight relation when the vacuum hood is in contact against a workpiece. The edge regions surround the negative pressure region and contact a surface of the workpiece in gas-tight relation therewith.

Because of the flexurally flexible configuration of the vacuum hood having the at least one coil layer, the induction heating apparatus can also be used on a workpiece having a surface that is for example curved or stepped. By way of the negative pressure region between the vacuum hood and the workpiece, a constant distance between the coil layer and the workpiece can be created even if the workpiece presents a curved or stepped surface.

By way of example, provision is made for an electrically conductive susceptor to be arranged between the surface of the workpiece and the vacuum hood. The susceptor is for example a thin metal sheet or metal mesh which also has a flexurally flexible configuration. Provision is made for the susceptor to be homogeneously heated by homogeneous magnetic fields which are created by the coil device. It is thereby possible for the curved surface of the workpiece to be heated homogeneously utilizing the induction heating apparatus.

The at least one coil layer is embedded in the structural material of the vacuum hood; in particular, the at least one coil layer is completely surrounded by the structural material of the vacuum hood. In particular, the structural material of the vacuum hood encloses the at least one coil layer on all sides thereof. The at least one coil layer is thereby integrated in the structural material of the vacuum hood. In this manner, the vacuum hood having the least one coil layer forms a single component that can be handled as a whole.

In particular, the at least one coil layer is surrounded by the structural material of the vacuum hood. The coil layer can thereby be fixed in a defined geometric position within the vacuum hood. The result is an integral component part consisting of vacuum hood plus coil layer and having a homogeneous outer surface which is formed by the structural material of the vacuum hood.

For example, the at least one coil layer is fixed within the vacuum hood by interlocking in form-locking connection with the structural material of the vacuum hood on all sides. This provides a simple way of integrating the at least one coil layer in the structural material of the vacuum hood.

It is particularly advantageous for the coil device to comprise a plurality of spiral-shaped windings which are arranged in rows and/or columns, and in particular wherein the spiral-shaped windings are configured such that when an electrical current flows through the spiral-shaped windings, a direction of current is at least approximately the same in adjacent peripheral winding sections of spiral-shaped windings adjacent in a row or column. By the corresponding configuration of the spiral-shaped windings, it is ensured that no mutual cancellation of electromagnetic fields occurs in the intermediate region between adjacent spiral-shaped windings. By the geometric arrangement of turns of the spiral-shaped windings via a corresponding arrangement and configuration of the peripheral winding sections, it is ensured that in said intermediate region the flow of current is in the same direction in adjacent spiral-shaped windings, thereby avoiding field attenuation.

Here, a peripheral winding section is a section of an outer turn.

By way of example, when a single spiral-shaped winding is provided, a highly inhomogeneous energy density distribution occurs. By the provision of a plurality of spiral-shaped windings having the configuration as described above, a homogenization of the energy density distribution is achieved in operation under current flow conditions, and this in turn allows homogeneous heating of component parts to be implemented.

It is thereby possible to implement homogenous heating relative to the area of the carrier on which spiral-shaped windings are arranged.

The spiral-shaped windings on the carrier, in a sense, form islands, wherein said islands are wound in such a way that field cancellation in the intermediate region between adjacent spiral-shaped windings is avoided.

In principle, the corresponding induction heating apparatus can be arbitrarily extended in terms of area.

For further details regarding the formation of the homogeneous field distribution by the coil device, reference is made to DE 20 2015 100 080 U1 of the same applicant. This document is incorporated herein and made a part hereof by reference in its entirety and for all purposes.

It is advantageous for the carrier to be formed by a fibre structure and/or by a mesh structure and for the coil device to be held to the carrier via one or more holding threads and in particular for the coil device to be sewn together with the carrier. The fibre structure of the carrier provides a simple way of implementing a flexurally flexible configuration. The holding threads provide a simple way of fixing the coil device to the carrier. A flexible carrier having a flexible coil device can thereby be implemented. Sewing together the coil device and the carrier provides a simple way of connecting the coil device to the carrier in a defined geometric position. In this respect, reference is made is made to DE 10 2013 111 266 A1 of the same applicant. This document is incorporated herein and made a part hereof by reference in its entirety and for all purposes.

In particular, the vacuum hood has an underside which, in operation of the vacuum hood apparatus, faces towards a workpiece. The vacuum hood comprises a channel device comprising at least one feed channel, wherein, by applying a negative pressure to the at least one feed channel, a negative pressure region can be created between the underside and the workpiece and/or wherein the workpiece can be infiltrated with a material via the at least one feed channel. This provides a simple way of creating a negative pressure region between the underside of the vacuum hood and the workpiece by operatively connecting the feed channel for fluid communication with a device for applying a negative pressure, such as a pump. It is further possible to infiltrate the workpiece with a material via the at least one feed channel. By way of example, provision is made for the workpiece to be infiltrated with a repair material, such as a resin, via the at least one feed channel when the induction heating apparatus is operated.

It is then advantageous for the vacuum hood to comprise at least one port which is operatively connected to the at least one feed channel for fluid communication therewith. This provides a simple way of establishing operative fluid communication between a device for applying a negative pressure and/or a device for feeding a material and the at least one feed channel.

Provision may be made for the vacuum hood to comprise at least one distributor and in particular for the at least one feed channel to open into the at least one distributor. This provides a simple way of establishing operative fluid communication between a channel structure which is for example arranged at the underside of the vacuum hood and the at least one distributor or the at least one feed channel.

It is advantageous for the channel device to comprise a channel structure having at least one channel at the underside of the vacuum hood, which channel is, at an opening thereof, open towards the underside and which in particular is operatively connected to the at least one feed channel for fluid communication therewith. This then allows for the application of negative pressure between the underside of the vacuum hood and the workpiece to be realized via the at least one channel of the channel structure. The negative pressure can thereby be applied over a large surface at the underside of the vacuum hood. Furthermore, this allows for the infiltration of the workpiece with a material via the at least one channel of the channel structure at the underside. The workpiece can thereby be infiltrated over a large surface thereof.

In particular, a sum of cross-sectional areas of the openings of all channels of the channel structure at the underside is at least 30% of the total area of the underside. The negative pressure can thereby be applied over a large portion of area of the total area of the underside. This makes for effective negative pressure application between the underside of the vacuum hood and the workpiece.

It is advantageous for the channels of the channel structure to be arranged uniformly across the underside. It is thereby possible for the negative pressure to be applied uniformly at the underside of the vacuum hood. In particular, in a portion of area of the underside that encompasses 25% of the total area of the underside, the sum of the cross-sectional areas of the openings of the channels of the channel structure that lie within said portion of area is at least 10% and at most 40% of the sum of the cross-sectional areas of the openings of all channels of the channel structure. In this way, a uniform arrangement of the channel structure can be implemented at the underside of the vacuum hood.

In particular, in a portion of area of the underside that encompasses 25% of the total area of the underside, the sum of the cross-sectional areas of the openings of the channels of the channel structure that lie within said portion of area is at least 15% and at most 35% of the sum of the cross-sectional areas of the openings of all channels of the channel structure.

In particular, the vacuum hood comprises a reinforcing structure which is embedded in the structural material of the vacuum hood and which is in particular made of a fibre structure. The dimensional stability of the vacuum hood can thereby be increased, whereby deformations of the vacuum hood, such as the formation of wrinkles or ripples, can be avoided. The vacuum hood can then be more easily made to lie flat against the workpiece. The use of a fibre structure makes the reinforcing structure easy to manufacture.

In an exemplary embodiment, the vacuum hood comprises at least one thermal insulation layer which is embedded in the structural material of the vacuum hood, in particular wherein the at least one coil layer is arranged between the at least one thermal insulation layer and the underside of the vacuum hood. It is thereby possible, in operation of the induction heating apparatus, to avoid the emission of heat radiation via a top side of the vacuum hood facing away from the workpiece. The efficiency of the induction heating apparatus is thereby enhanced.

In particular, provision is made for the vacuum hood to have at least one sensor associated therewith. The at least one sensor can be arranged at the underside of the vacuum hood for example. This allows measured values to be sensed when the vacuum hood is operated, and these can be utilized to control certain parameters, as are for example pressure and/or temperature.

In an exemplary embodiment, the vacuum hood comprises a fixing device having at least one lug and at least one opening. The fixing device provides a simple way of fixing the vacuum hood to a workpiece in a certain position. It is thereby possible to prevent the vacuum hood from slipping off the workpiece.

It is then advantageous for the at least one lug to be connected in one piece to the vacuum hood. An integral component part consisting of vacuum hood plus lug is thereby formed.

It is advantageous for the vacuum hood to be made of a castable and/or injection mouldable structural material. This provides a simple way of manufacturing the vacuum hood by injection moulding.

In particular, the structural material of the vacuum hood is a silicone material. This provides a simple way of implementing a flexurally flexible configuration of the vacuum hood.

In an exemplary embodiment, provision is made for at least one additional layer to be releasably connected to the vacuum hood via a connecting device and in particular for the at least one additional layer to be of flexurally flexible configuration. Thus, the vacuum hood can be flexibly and easily extended or reduced by adding or removing parts of it respectively. The vacuum hood configuration can be flexibly adapted to suit the needs of the particular use. A flexurally flexible configuration of the additional layer provides for the vacuum hood having the additional layer to be flexurally flexible and capable of being used on curved surfaces.

It is then advantageous for the connecting device to comprise at least one magnet and/or at least one hook-and-loop connection. This provides a simple way of implementing a releasable connection between the at least one additional layer and the vacuum hood.

In accordance with an exemplary embodiment of the invention, a repair method using an induction heating apparatus is provided, the induction heating apparatus comprising:

at least one coil layer having a coil device and a carrier, on which carrier the coil device is arranged;

wherein the at least one coil layer is of flexurally flexible configuration;

wherein the at least one coil layer is embedded in the structural material of a vacuum hood; and

wherein the vacuum hood having the at least one coil layer is of flexurally flexible configuration;

said repair method comprising:

applying the induction heating apparatus to a repair region of a workpiece;

creating a negative pressure region between the workpiece and the vacuum hood; and

heating a material in the repair region, wherein the heating of the material is realized via a susceptor arranged in the repair region, which susceptor is inductively heated by way of the induction heating apparatus.

The repair method in accordance with the invention has the advantages that have already been described in connection with the induction heating apparatus in accordance with the invention.

Further advantageous embodiments have also been described in connection with the induction heating apparatus constructed in accordance with the invention.

In accordance with an exemplary embodiment of the invention, a vacuum hood apparatus is provided which can be used on workpieces of different geometries while having a compact construction.

In accordance with an exemplary embodiment of the invention, said vacuum hood apparatus comprises:

a vacuum hood;

wherein the vacuum hood has an underside which, in operation of the vacuum hood apparatus, faces towards a workpiece;

wherein the vacuum hood comprises a channel device comprising at least one feed channel and a channel structure having at least one channel at the underside; and

wherein the at least one channel of the channel structure is, at an opening thereof, open towards the underside and is operatively connected to the at least one feed channel for fluid communication therewith;

wherein a sum of cross-sectional areas of the openings of the channels of the channel structure at the underside is at least 30% of the total area of the underside.

The vacuum hood apparatus in accordance with the invention has the advantages that have already been described in connection with the vacuum hood of the induction heating apparatus in accordance with the invention.

Further advantageous embodiments have already been described in connection with the vacuum hood of the induction heating apparatus in accordance with the invention.

The vacuum hood has an underside which, in operation of the vacuum hood apparatus, faces towards a workpiece. The vacuum hood comprises a channel device. The channel device comprises a channel structure having at least one channel at the underside of the vacuum hood, which channel is, at an opening thereof, open towards the underside and which in particular is operatively connected to the at least one feed channel for fluid communication therewith. A sum of cross-sectional areas of the openings of all channels of the channel structure at the underside is at least 30% of the total area of the underside. The negative pressure can thereby be applied over a large portion of area of the total area of the underside. This makes for effective negative pressure application between the underside of the vacuum hood and the workpiece.

It is advantageous for the channels of the channel structure to be arranged uniformly across the underside. It is thereby possible for the negative pressure to be applied uniformly at the underside of the vacuum hood. In particular, in a portion of area of the underside that encompasses 25% of the total area of the underside, the sum of the cross-sectional areas of the openings of the channels of the channel structure that lie within said portion of area is at least 10% and at most 40% of the sum of the cross-sectional areas of the openings of all channels of the channel structure. In this way, a uniform arrangement of the channel structure can be implemented at the underside of the vacuum hood.

In particular, in a portion of area of the underside that encompasses 25% of the total area of the underside, the sum of the cross-sectional areas of the openings of the channels of the channel structure that lie within said portion of area is at least 15% and at most 35% of the sum of the cross-sectional areas of the openings of all channels of the channel structure.

It is advantageous if, by applying a negative pressure to the at least one feed channel, a negative pressure region can be created between the underside and the workpiece and/or the workpiece can be infiltrated with a material via the at least one feed channel. This then allows for the application of negative pressure between the underside of the vacuum hood and the workpiece to be realized via the at least one channel of the channel structure which is operatively connected to the at least one feed channel for fluid communication therewith. The negative pressure can thereby be applied over a large surface at the underside of the vacuum hood. Furthermore, this allows for the infiltration of the workpiece with a material via the at least one channel of the channel structure at the underside. The workpiece can thereby be infiltrated over a large surface thereof.

It is advantageous for the vacuum hood to comprise at least one port which is operatively connected to the at least one feed channel for fluid communication therewith. This provides a simple way of establishing operative fluid communication between a device for applying a negative pressure and/or a device for feeding a material and the at least one feed channel.

Provision may be made for the vacuum hood to comprise at least one distributor and in particular for the at least one feed channel to open into the at least one distributor. This provides a simple way of establishing operative fluid communication between a channel structure which is for example arranged at the underside of the vacuum hood and the at least one distributor or the at least one feed channel.

In particular, the vacuum hood comprises a reinforcing structure which is embedded in the structural material of the vacuum hood and which is in particular made of a fibre structure. The dimensional stability of the vacuum hood can thereby be increased, whereby deformations of the vacuum hood, such as the formation of wrinkles or ripples, can be avoided. The vacuum hood can then be more easily made to lie flat against the workpiece. The use of a fibre structure makes the reinforcing structure easy to manufacture.

In an exemplary embodiment the vacuum hood comprises at least one thermal insulation layer which is embedded in the structural material of the vacuum hood, in particular wherein the at least one coil layer is arranged between the at least one thermal insulation layer and the underside of the vacuum hood. It is thereby possible, in operation of the induction heating apparatus, to avoid the emission of heat radiation via a top side of the vacuum hood facing away from the workpiece. The efficiency of the vacuum hood apparatus is thereby enhanced.

In particular, provision is made for the vacuum hood to have at least one sensor associated therewith. The at least one sensor can be arranged at the underside of the vacuum hood for example. This allows measured values to be sensed when the vacuum hood is operated, and these can be utilized to control certain parameters, as are for example pressure and/or temperature.

In an exemplary embodiment, the vacuum hood comprises a fixing device having at least one lug and at least one opening. The fixing device provides a simple way of fixing the vacuum hood to a workpiece in a certain position. The vacuum hood can thereby be prevented from slipping off the workpiece.

It is then advantageous for the at least one lug to be connected in one piece to the vacuum hood. An integral component part consisting of vacuum hood plus lug is thereby formed.

It is advantageous for the vacuum hood to be made of a castable and/or injection mouldable structural material. This provides a simple way of manufacturing the vacuum hood by injection moulding.

In particular, the structural material of the vacuum hood is a silicone material. This provides a simple way of implementing a flexurally flexible configuration of the vacuum hood.

In an exemplary embodiment, provision is made for at least one additional layer to be releasably connected to the vacuum hood via a connecting device and in particular for the at least one additional layer to be of flexurally flexible configuration. Thus, the vacuum hood can be flexibly and easily extended or reduced by adding or removing parts of it respectively. The vacuum hood configuration can be flexibly adapted to suit the needs of the particular use. A flexurally flexible configuration of the additional layer provides for the vacuum hood having the additional layer to be flexurally flexible and capable of being used on curved surfaces.

It is then advantageous for the connecting device to comprise at least one magnet and/or at least one hook-and-loop connection. This provides a simple way of implementing a releasable connection between the at least one additional layer and the vacuum hood.

The following description of preferred embodiments serves in conjunction with the drawings to explain the invention in greater detail.

### BRIEF DESCRIPTION OF THE DRAWINGS

FIG. 1 shows a schematic perspective view illustrating a first exemplary embodiment of an induction heating apparatus in accordance with the invention;

FIG. 2 shows a sectional view along line 2-2 in FIG. 1;

FIG. 3 shows a schematic sectional view illustrating a second exemplary embodiment of an induction heating apparatus in accordance with the invention;

FIG. 4 shows a schematic sectional view illustrating a third exemplary embodiment of an induction heating apparatus in accordance with the invention;

FIG. 5 shows a schematic sectional view illustrating a fourth exemplary embodiment of an induction heating apparatus in accordance with the invention;

FIG. 6 shows a schematic sectional view illustrating a fifth exemplary embodiment of an induction heating apparatus in accordance with the invention;

FIG. 7 shows a schematic sectional view illustrating a sixth exemplary embodiment of an induction heating apparatus in accordance with the invention;

FIG. 8 shows a top view of the induction heating apparatus in FIG. 7;

FIG. 9A shows a view illustrating a first exemplary embodiment of a channel structure;

FIG. 9B shows a sectional view along line 4-4 in FIG. 9A;

FIG. 9C shows a view illustrating a second exemplary embodiment of a channel structure;

FIG. 9D shows a sectional view along line 6-6 in FIG. 9C;

FIG. 9E shows a view illustrating a third exemplary embodiment of a channel structure;

FIG. 9F shows a sectional view along line 8-8 in FIG. 9E;

FIG. 9G shows a view illustrating a fourth exemplary embodiment of a channel structure;

FIG. 9H shows a sectional view along line 10′-10′ in FIG. 9G;

FIG. 10A shows a schematic sectional view illustrating a seventh exemplary embodiment of an induction heating apparatus in accordance with the invention;

FIG. 10B shows a schematic sectional view illustrating an eighth exemplary embodiment of an induction heating apparatus in accordance with the invention;

FIG. 10C shows a schematic sectional view illustrating a ninth embodiment of an induction heating apparatus in accordance with the invention;

FIG. 11 shows a schematic sectional view illustrating a first exemplary embodiment of a vacuum hood apparatus in accordance with the invention;

FIG. 12 shows a schematic sectional view illustrating a second exemplary embodiment of a vacuum hood apparatus in accordance with the invention;

FIG. 13 shows a schematic sectional view illustrating a third exemplary embodiment of a vacuum hood apparatus in accordance with the invention;

FIG. 14 shows a schematic sectional view illustrating a fourth exemplary embodiment of a vacuum hood apparatus in accordance with the invention;

FIG. 15 shows a schematic sectional view illustrating a fifth exemplary embodiment of a vacuum hood apparatus in accordance with the invention;

FIG. 16 shows a schematic sectional view illustrating a sixth exemplary embodiment of a vacuum hood apparatus in accordance with the invention;

FIG. 17 shows a top view of the vacuum hood apparatus in FIG. 16;

FIG. 18A shows a view illustrating a first exemplary embodiment of a channel structure;

FIG. 18B shows a sectional view along line 4-4 in FIG. 18A;

FIG. 18C shows a view illustrating a second exemplary embodiment of a channel structure;

FIG. 18D shows a sectional view along line 6-6 in FIG. 18C;

FIG. 18E shows a view illustrating a third exemplary embodiment of a channel structure;

FIG. 18F shows a sectional view along line 8-8 in FIG. 18E;

FIG. 18G shows a view illustrating a fourth exemplary embodiment of a channel structure;

FIG. 18H shows a sectional view along line 10′-10′ in FIG. 18G;

FIG. 19A shows a schematic sectional view illustrating a seventh exemplary embodiment of a vacuum hood apparatus in accordance with the invention;

FIG. 19B shows a schematic sectional view illustrating an eighth exemplary embodiment of a vacuum hood apparatus in accordance with the invention; and

FIG. 19C shows a schematic sectional view illustrating a ninth embodiment of a vacuum hood apparatus in accordance with the invention.

### DETAILED DESCRIPTION OF THE INVENTION

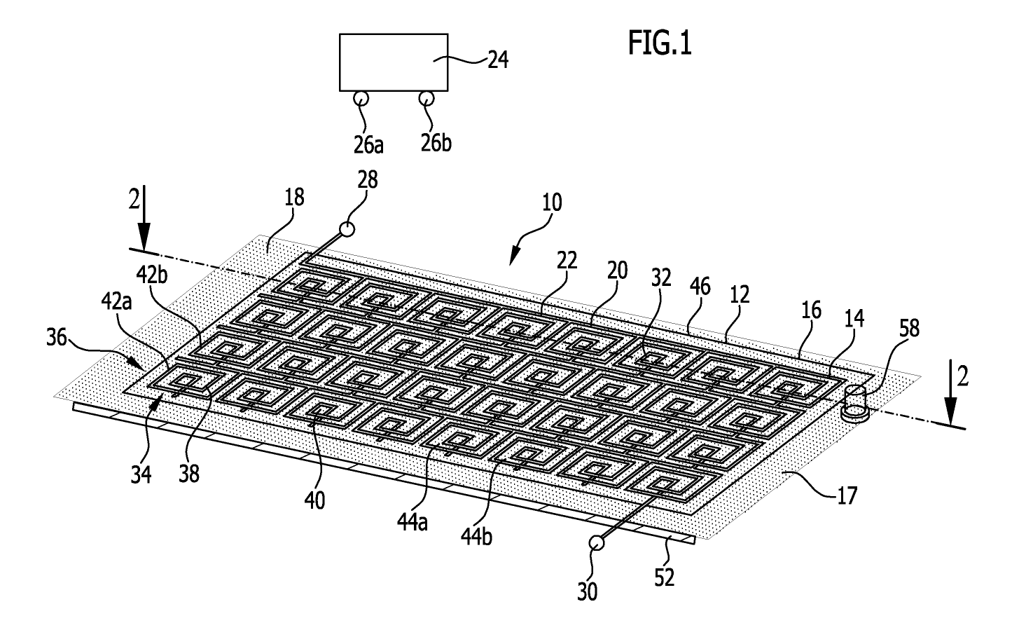

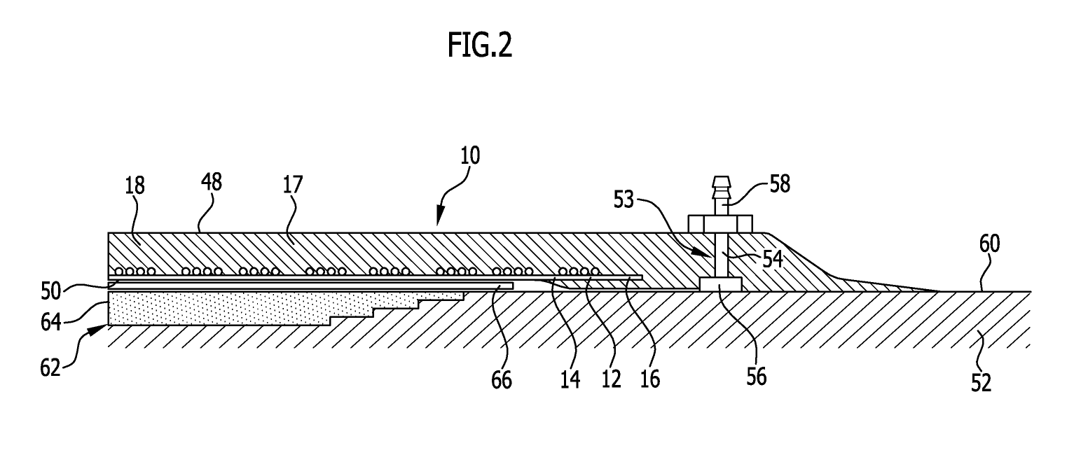

A first exemplary embodiment of an induction heating apparatus, shown schematically in FIG. 1 and FIG. 2 and designated therein by 10, comprises a coil layer 12 having a coil device 14 and a carrier 16. The coil layer 12 is embedded in the structural material 17 of a vacuum hood 18.

The carrier 16 is made of an electrically insulating material. It is, for example, a fibre structure and a textile structure, such as a woven or knitted fabric.

The coil device 14 is arranged on the carrier 16. The coil device is formed by a current-carrying high-frequency Litz wire 20.

The carrier 16 having the coil device 14 is of flexurally flexible configuration as a whole.

The high-frequency Litz wire 20 serves to carry a high-frequency alternating current. The high-frequency Litz wire 20 is a wire bundle of individual wires that are mutually electrically insulated by insulation. It is thereby possible to effectively increase the cross-sectional area over which electrical current flows when compared to a solid wire, thus reducing the influence of the skin effect. In addition, the crowding of charge carriers towards one side of the corresponding conductor as caused by the magnetic field generated by a coil provided thereon (proximity effect) is also reduced.

In an embodiment, the bundle of wires is arranged in a sheath 22 which is in particular multi-layered.

For further details regarding the configuration of the high-frequency Litz wire 20, reference is made to DE 10 2013 111 266 A1 and DE 20 2015 100 080 U1 of the same applicant. These documents are incorporated herein and made a part hereof by reference in their entirety and for all purposes.

The coil device 14 has a high-frequency source device 24 associated therewith (cf. FIG. 1). In operation of the induction heating apparatus 10, the individual wires of the wire bundle of the high-frequency Litz wire 20 are operatively connected to corresponding terminals 26a, 26b of the high-frequency source device 24 for electrical communication therewith.

To this end, the high-frequency Litz wire 20 has a terminal 28 at a first end thereof and has a terminal 30 at a second end thereof.

The high-frequency source device 24 serves to generate a high-frequency electromagnetic alternating field which is applied to the high-frequency Litz wire 20. The frequency is at least 20 kHz and is typically at approximately 150 kHz.

The high-frequency source device 24 comprises an electronic switching device for creating the corresponding alternating field when the primary electrical source is a direct current source.

In particular, the high-frequency Litz wire 20 is of flexurally flexible configuration.

The coil device 14 comprises a plurality of spiral-shaped windings 32. These spiral-shaped windings 32 are arranged on the carrier 16 in rows 34 and columns 36. The spiral-shaped windings 32 are arranged on the carrier 16 in a uniformly distributed relation for forming an area induction heating apparatus 10. The spiral-shaped windings 32 are formed on the high-frequency Litz wire 20.

In particular, by the rows 34 and columns 36, the spiral-shaped windings 32 are arranged on the carrier 16 in a two-dimensional grid. This two-dimensional grid is in particular a rectangular grid and is preferably a square grid.

A respective spiral-shaped winding 32 has a plurality of turns 38 which are related to a starting point 40. A starting point 40 lies on a winding axis of the turns 38 of the spiral-shaped winding 32. The winding axis is oriented perpendicularly to the carrier 16. The spiral of a spiral-shaped winding 32 is defined as a curve receding from or approaching the starting point 40 or winding axis. Here, the recession can be monotonically increasing or the approach can be monotonically decreasing, or the recession and the approach can be increasing and decreasing in sections, respectively.

The arrangement of the spiral-shaped windings 32 on the carrier 16 dictates the temperature distribution that will occur at an object to be heated.

In accordance with the invention, the coil device 14 is configured such that a homogeneous field distribution is achieved across the area of the coil device 14 and in particular such that a “field cancellation” of the generated magnetic fields is avoided in the region between adjacent spiral-shaped windings 32.

When a current is passed through a spiral-shaped winding 32, the direction of rotation of the through-flowing current is in the same direction within a spiral-shaped winding 32. In accordance with the invention, it is provided that both for rows 34 and for columns 36, the direction of rotation for the current flow in adjacent spiral-shaped windings 42a, 42b and 44a, 44b respectively is in opposite direction. It is thereby possible for the described cancellation of the magnetic field to be avoided.

The spiral-shaped windings 32 of the coil device 14 are electrically connected in series. In the illustrated exemplary embodiment (FIG. 1), the spiral-shaped windings 32 are connected in series, one after another, in a row 34. The corresponding rows 34, in turn, are connected in series.

For further details regarding the formation of the homogeneous field distribution by the coil device 14, reference is made to DE 20 2015 100 080 U1 of the same applicant. This document is incorporated herein and made a part hereof by reference in its entirety and for all purposes.

The carrier 16 has a first side 46 and a second side located opposite the first side. It is preferred for the high-frequency Litz wire 20 to be arranged exclusively or for the most part on the first side 46.

The corresponding winding axes of the spiral-shaped windings 32 are transverse and in particular perpendicular to the carrier 16.

The high-frequency Litz wire 20 is fixed to, and in particular sewn together with, the carrier 16 by way of one or more holding threads. The winding structure of the coil device 14 on the carrier 16 is also formed by this fixing scheme using holding threads.

With respect to the fixing of the coil device 14 to the carrier 16 via holding threads, reference is made to DE 10 2013 111 266 A1 of the same applicant.

This document is incorporated herein and made a part hereof by reference in its entirety and for all purposes.

Furthermore, outer electrical insulation layers may be provided between which the carrier 16 having the coil device 14 fixed thereto is then arranged. Such outer electrical insulation layers are, for example, made of a silicone material.

The outer electrical insulation layers are of flexurally flexible configuration.

The carrier 16 is of flexurally flexible configuration. The high-frequency Litz wire 20 together with the carrier 16 is capable of being flexed. The connection of the high-frequency Litz wire 20 to the carrier 16 via holding threads provides the capability of flexing.

The induction heating apparatus 10 is configured as an area induction heating apparatus in which regions having electromagnetic fields that cancel each other out are avoided by the arrangement of the spiral-shaped windings 32. It is thereby possible to achieve homogeneous heating with high flexibility.

The spiral-shaped windings 32 on the carrier 16 form field-generating islands. By appropriate configuration of the islands, the “heating surface” can, in principle, be arbitrarily extended or a size adjustment can be made. This is then achieved by appropriate “lay” of the high-frequency Litz wire 20 on the carrier 16.

The vacuum hood 18 is in particular made of a structural material 17 which is flexurally flexible, gas-tight and electrically insulating. The structural material 17 of the vacuum hood 18 is a silicone material for example.

The coil layer 12 is embedded in the structural material 17 of the vacuum hood 18. In particular, it is completely surrounded by the structural material 17 of the vacuum hood 18.

In particular, the structural material 17 of the vacuum hood 18 is in form-locking contact against the first side 46 and the second side, opposite the first side 46, of the carrier 16 and against the coil device 14. The coil layer 12 is thereby fixed in a fixed position within the vacuum hood 18.

The vacuum hood 18 together with the coil layer 12 forms an integral component. Said integral component as a whole is of flexurally flexible configuration.

The precursor material of the vacuum hood 18 is in particular castable and injection mouldable. This makes it possible for the coil layer 12 to be embedded in the structural material 17 of the vacuum hood 18 by injection moulding.

To this end, for example, the coil layer 12 is placed on a first material layer.

The first material layer having the coil layer 12 placed thereon is then arranged in a mould and liquefied material is injected under pressure using an injection moulding tool. The liquefied material surrounds the coil layer 12 in a form-locking relation therewith and contacts the first material layer. Once the injected material has solidified, a substance-to-substance bond is formed between the first material layer and the injected material. The whole of the material forms the structural material 17 of the vacuum hood 18. The coil layer 12 is embedded in the structural material 17. In this way, the coil layer 12 can be embedded in the structural material 17 of the vacuum hood 18 by injection moulding.

The vacuum hood 18 has a top side 48 and an underside 50. In operation of the induction heating apparatus 10, the underside 50 faces towards a workpiece 52 and the top side 48 faces away from the workpiece 52.

The carrier 16 of the coil device 14 is located between the top side 48 and the underside 50.

The vacuum hood 18 comprises a channel device 53 having at least one feed channel 54 which runs from the top side 48 towards the underside 50. The feed channel 54 extends transversely relative to the top side 48 and the underside 50.

At the underside 50, the feed channel 54 opens into a distributor 56. Connected to the distributor 56 are one or more channels of the channel device 53, in particular wherein the channels run at the underside 50 and/or are open towards the underside 50.

Arranged at the mouth of the feed channel 54 opening towards the top side 48 is a port 58. Provision is made for the port 58 to be operatively connected for fluid communication with a device for applying a vacuum, such as a pump. In this manner, a negative pressure region can be created between a side 60 of the workpiece 52 and the underside 50 which is at least partially in contact with the side 60.

The workpiece 52 is, for example, a fibre composite material component part having a repair region 62 that contains damage. Arranged in the repair region 62 is a repair patch 64 which comprises for example a repair resin.

Arranged between the repair region 62 and the vacuum hood 18 is a susceptor 66. The susceptor 66 is a loose constituent part of the induction heating apparatus 10. It is positioned in spaced relation to the coil device 14 and is electrically separated therefrom via the structural material 17. The susceptor 66 is of electrically conductive and in particular flexurally flexible configuration.

By way of example, the susceptor 66 is a thin metal sheet or metal mesh.

Provision is made for the susceptor 66 to be inductively heated by the magnetic fields which are generated by the coil device 14 of the induction heating apparatus 10. In operation of the induction heating apparatus 10, the coil device 14 of the coil layer 12 is approximately parallel to the susceptor 66.

In operation of the induction heating apparatus 10, a negative pressure region is created between the side 60 of the workpiece 52 and the underside 50 of the vacuum hood 18 by the application of vacuum. By virtue of the negative pressure region, the vacuum hood 18 is urged against the side 60 of the workpiece 52. An approximately constant distance is thereby established between the coil device 14 and the susceptor 66. The susceptor 66 is heated homogeneously by the in particular homogeneous magnetic fields generated by the coil device 14. The susceptor 66 in turn heats the repair patch 64, whose repair material can bond in a substance-to-substance bond with the material of the workpiece 52 by the heat in the repair region 62. After completion of the repair process and with the application of negative pressure deactivated, the vacuum hood 18 can be removed from the workpiece 52 without leaving a residue and can be used for further repair processes.

In the embodiments of an induction heating apparatus in accordance with the invention as described in the following, the same reference characters are used to denote components that are identical to those of the induction heating apparatus 10 illustrated in the first embodiment. What has been described regarding these components of the first embodiment also applies to the other embodiments.

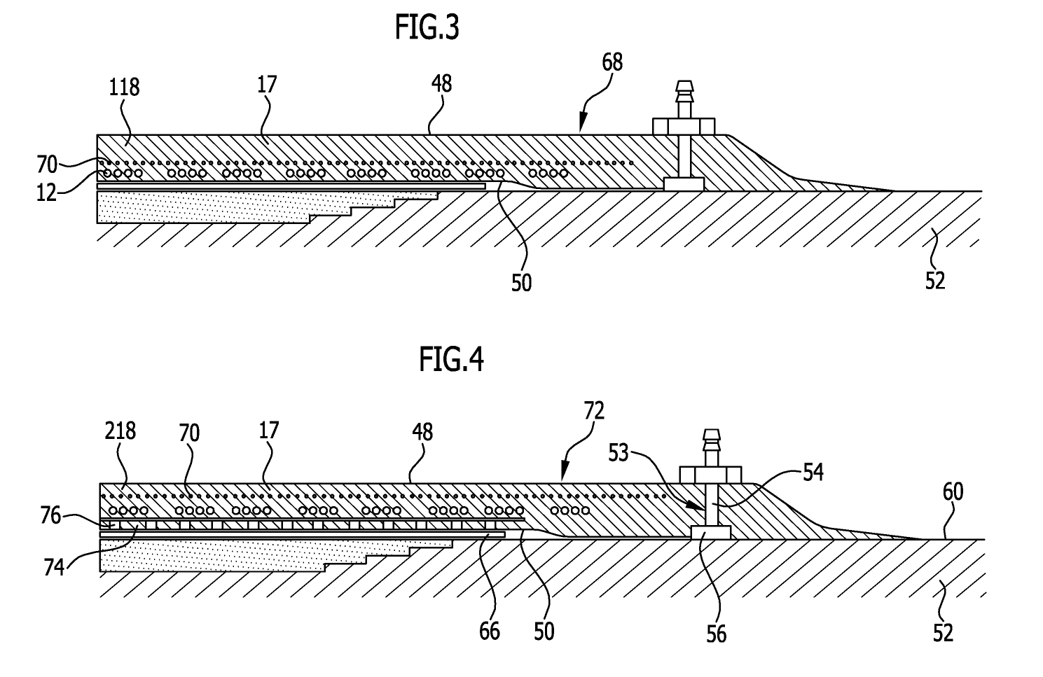

In a second embodiment of an induction heating apparatus 68 in accordance with the invention (FIG. 3) comprising a vacuum hood 118, the vacuum hood 118 comprises a reinforcing structure 70 which is embedded in the structural material 17 of the vacuum hood 118. The reinforcing structure 70 is made of an electrical insulator material. It is in particular of flexurally flexible configuration. The reinforcing structure 70 is in particular a textile structure, such as a woven or knitted fabric.

In particular, the reinforcing structure 70 is located between the coil layer 12 and the top side 48 of the vacuum hood 118. The reinforcing structure 70 is in particular of sheet-like configuration.

By the use of the reinforcing structure 70, the dimensional stability of the vacuum hood 118 can be increased. In this way, deformations of the vacuum hood 18, such as deformations caused by wrinkling, can largely be avoided when operating the induction heating apparatus 68.

In a third embodiment of an induction heating apparatus 72 in accordance with the invention (FIG. 4) comprising a vacuum hood 218, the channel device 53 comprises, at the underside 50 of the vacuum hood 218, a channel structure 74 having at least one channel. The channel structure 74 is arranged at the underside 50.

In operation of the induction heating apparatus 72, the channels of the channel structure 74 are, at an opening thereof, open to the side 60 of the workpiece 52 or towards the susceptor 66.

The underside 50 of the vacuum hood 218 has wall elements 76 which form projections at the underside 50 and which, in operation of the induction heating apparatus 72, are at least partially in contact against the side 60 of the workpiece 52 or against the susceptor 66. The wall elements 76 form the walls of the channel structure 74. The channel structure 74 is formed in the interspaces between the wall elements 76.

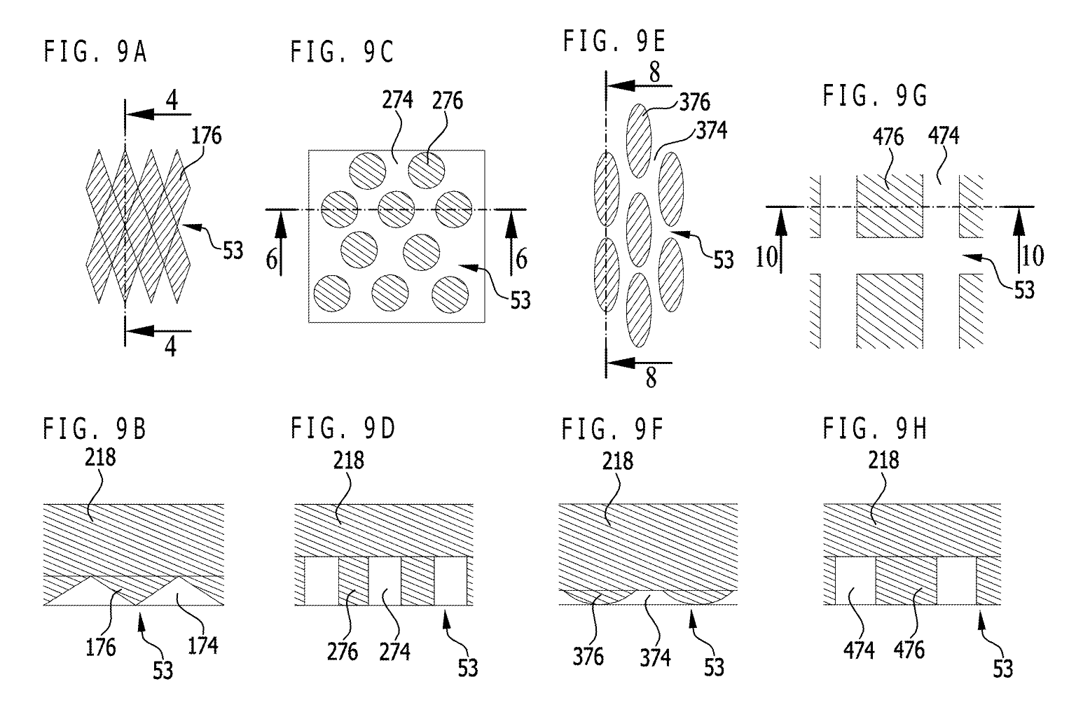

The wall elements 76 can present different geometric configurations. By way of example, the wall elements 176 are pyramids, the wall elements 276 are cylinders, the wall elements 376 are semi-ellipsoids and the wall elements 476 are cuboids. They present different cross-sectional shapes when viewed perpendicularly relative to the underside 50 of the vacuum hood 218. The wall elements 176 (FIG. 9A) have a rhombic cross-sectional shape, the wall elements 276 (FIG. 9C) have a circular cross-sectional shape, the wall elements 376 (FIG. 9E) have an elliptical cross-sectional shape and the wall elements 476 (FIG. 9G) have a rectangular cross-sectional shape. The channel structures 174, 274, 374, 474 are formed in the interspaces between the wall elements 176, 276, 376, 476 respectively. The vertical cross-sectional shapes in a section taken perpendicularly to the underside 50 of the vacuum hood 218 are triangles for the wall elements 176 (FIG. 9B), squares for the wall elements 276 (FIG. 9D), semi-ellipses for the wall elements 376 (FIG. 9F) and rectangles for the wall elements 476 (FIG. 9H).

By way of example, the wall elements 76, or the channel structure 74, are or is fabricated by removing material from the vacuum hood 218 in the interspaces between the wall elements 76.

The channel structure 74 can also be produced by an injection moulding process using a suitable mould. To this end, the mould has recesses conforming to the geometry of the wall elements 76. The recesses are filled with the precursor material of the vacuum hood 218 during the injection moulding process. The material present in the recesses of the mould later forms the wall elements 76 in the form of projections at the underside 50 of the vacuum hood 218.

In particular, the channel structure 74 is operatively connected for fluid communication with the distributor 56 of the feed channel 54 for applying a vacuum. The negative pressure can thereby be applied over a large area at the underside 50. In this manner, the application of negative pressure can be performed more effectively and the negative pressure region between the underside 50 of the vacuum hood 218 and the side 60 of the workpiece 52 can be enhanced.

Alternatively or in addition, the channel structure 74 can be utilized to supply to the workpiece 52 an infiltration material, such as a resin, when the induction heating apparatus 72 is operated.

In particular, a sum of cross-sectional areas of the openings of the channels of the channel structure 74 at the underside 50 is at least 30% of the total area of the underside 50. The negative pressure can thereby be applied over a large area at the underside 50.

In particular, the sum of the cross-sectional areas of the openings of the channels of the channel structure 74 at the underside 50 is at least 40%, at least 50%, at least 60%, at least 70%, at least 80% or at least 90% of the total area of the underside 50.

In particular, the channels of the channel structure 74 are arranged uniformly over the underside 50. Provision is made that a uniform arrangement of the channels of the channel structure 74 is implemented in that in a portion of area of the underside 50 that encompasses 25% of the total area of the underside 50, the sum of the cross-sectional areas of the openings of the channels of the channel structure 74 that lie within said portion of area is at least 10% and at most 40% of the sum of the cross-sectional areas of the openings of all channels of the channel structure 74.

In particular, the sum of the cross-sectional areas of the openings of the channels of channel structure 74 that lie within said portion of area is at least 15% or at least 20%.

In particular, the sum of the cross-sectional areas of the openings of the channels of channel structure 74 that lie within said portion of area is at most 30% or at most 35%.

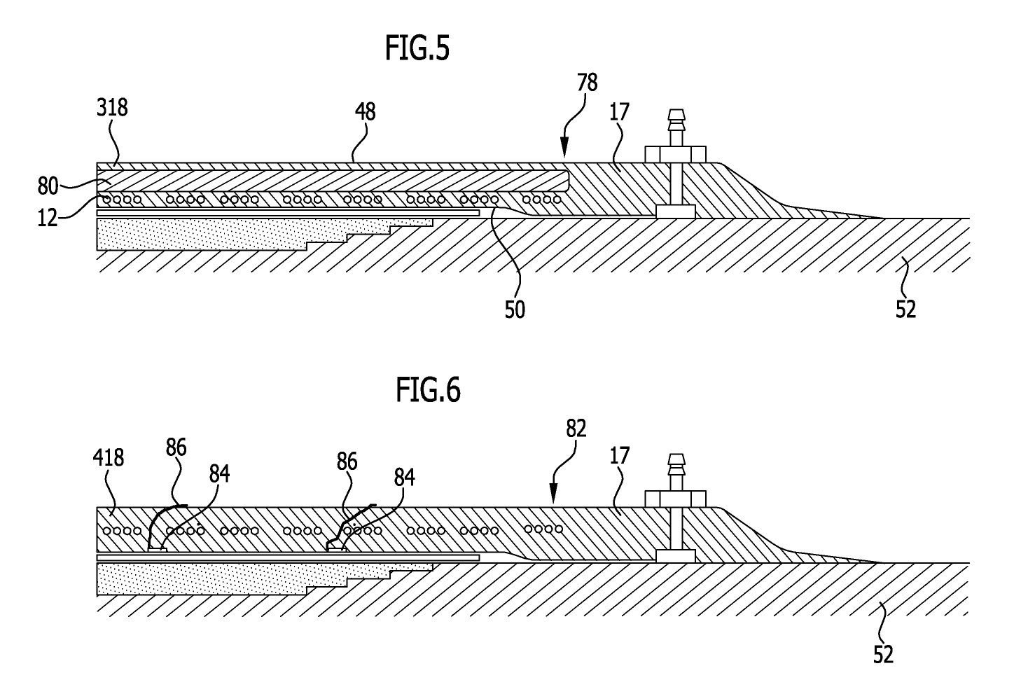

In a fourth embodiment of an induction heating apparatus 78 in accordance with the invention (FIG. 5) comprising a vacuum hood 318, the vacuum hood 318 comprises a thermal insulation layer 80 which is embedded in the structural material 17 of the vacuum hood 318. The thermal insulation layer 80 is in particular arranged between the coil layer 12 and the top side 48.

In particular, the thermal insulation layer 80 is of sheet-like configuration. The thermal insulation layer 80 is made of an electrical insulator material. The material of the thermal insulation layer 80 has a thermal conductivity lower than that of the structural material 17 of the vacuum hood 318. The thermal insulation layer 80 is made, for example, of a heat-insulating plastics material, such as polystyrene.

By the use of the thermal insulation layer 80, the emission of heat radiation via the top side 48 of the vacuum hood 318 can be avoided or at least reduced when the induction heating apparatus 78 is operated. The efficiency of the induction heating apparatus 78 is thereby increased.

In a fifth embodiment of an induction heating apparatus 82 in accordance with the invention (FIG. 6) comprising a vacuum hood 418, the vacuum hood 418 comprises at least one sensor 84 which is arranged at the underside 50. The sensor 84 can be at least partially embedded in the material of the vacuum hood 418. The sensor 84 has a supply line 86 which is operatively connected to the sensor 84 for electrical communication therewith and is routed through the material of the vacuum hood 418 to the outside.

The sensor 84 is, for example, a temperature sensor or a pressure sensor.

The use of the sensor 84 allows measured values to be sensed at the underside 50 of the vacuum hood 418 when the induction heating apparatus 82 is operated. These measured values can be used, for example, to control parameters such as pressure and/or temperature.

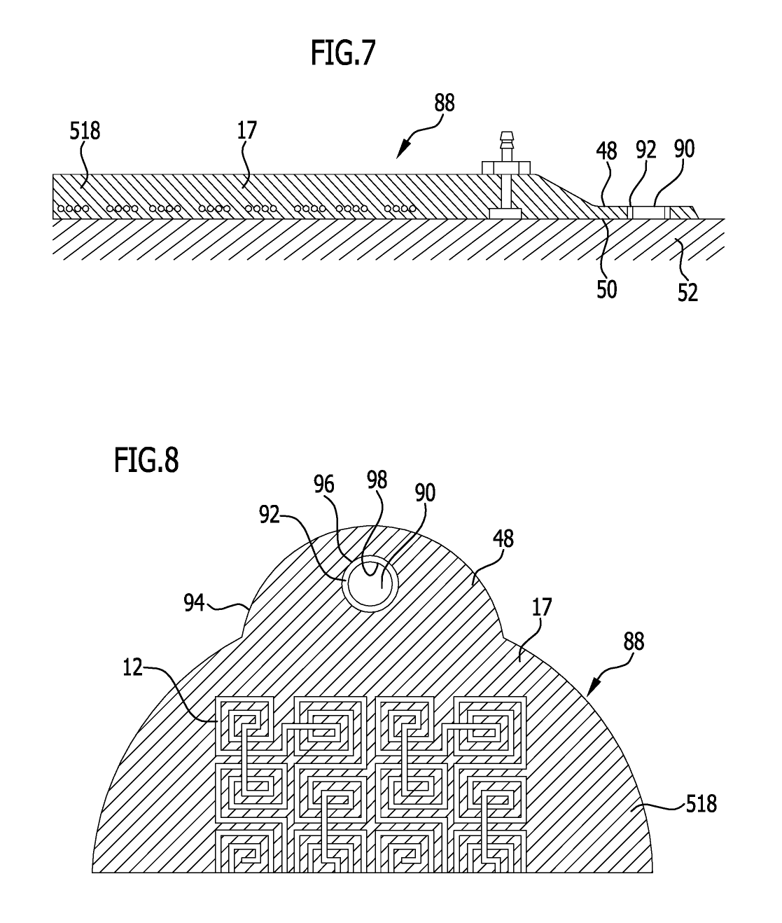

In a sixth embodiment of an induction heating apparatus 88 in accordance with the invention (FIG. 7 and FIG. 8) comprising a vacuum hood 518, the vacuum hood 518 comprises a fixing device having a lug and an opening 90. The boundary of the opening 90 has an edge element 92.

In particular, the lug is connected in one piece to the vacuum hood 518. By way of example, the lug and the vacuum hood 518 are made of the same structural material 17. An integral component part consisting of vacuum hood 518 and lug can thereby be produced in a single work step and using injection moulding techniques.

The opening 90 is preferably located in an area between the coil layer 12 and an outer boundary 94 of the vacuum hood 518. It extends from the top side 48 to the underside 50.

The edge element 92 has an inner side 96 facing towards the opening 90 and an outer side 98 facing towards the structural material 17 of the vacuum hood 518. The outer side 98 contacts the structural material 17 of the vacuum hood 518. Alternatively or in addition, the edge element 92 can be embedded at least partially in the structural material 17 of the vacuum hood 518.

Provision is made for the vacuum hood 518 having the opening 90 to be fastened to an external fastening device and/or to the workpiece 52. In particular, the external fastening device is passed through the opening 90 of the vacuum hood 518. It contacts the inner side 96 of the edge element 92 at least partially. Forces can thereby be exerted on the vacuum hood 518, whereby the vacuum hood 518 can be fixed at a position.

By way of example, the external fastening device can be a hook or a rope which is passed through the opening 90.

In this way, it is for example possible for the induction heating apparatus 88 to be fixed and brought in contact against a workpiece 52 in vertical relation to the floor surface before the application of vacuum is activated.

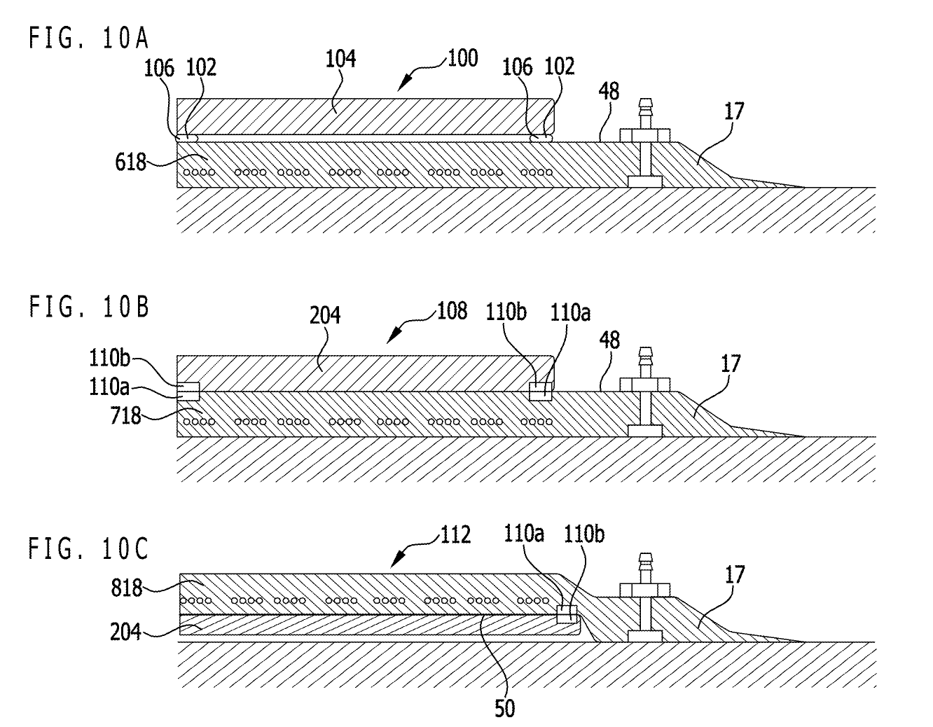

In a seventh embodiment of an induction heating apparatus 100 in accordance with the invention (FIG. 10A) comprising a vacuum hood 618, provision is made for at least one additional layer 104 to be releasably connectable to the top side 48 of the vacuum hood 618 via a connecting device having at least one connecting element 102.

By way of example, the additional layer 104 can be the thermal insulation layer 80, the reinforcing structure 70 or a flow aid for a resin material.

The connecting element 102 is arranged at the top side 48 of the vacuum hood 618 and is fixedly connected to the top side 48. By way of example, the connecting element 102 is substance to substance bonded to the top side 48 using an adhesive material.

The additional layer 104 in turn likewise comprises a connecting element 106 which is fixedly connected thereto and is releasably connectable to the connecting element 102 of the vacuum hood 618.

In particular, the connecting element 102 represents a counterpart to the connecting element 106. By way of example, the connecting elements 102, 106 are configured as a hook-and-loop connection. In this case, the connecting element 102 represents the counterpart of a hook-and-loop fastener to that of the connecting element 106. The connecting elements 102, 106 can alternatively be configured as a snap fastener type connection. The connecting element 102 in this case comprises a stud and the connecting element 106 comprises its counterpart (or vice versa).

In particular, the additional layer 104 is of flexurally flexible configuration.

Provision may be made for a releasable connection between the additional layer 204 and the top side 48 to be made via a plurality of connecting elements 104, 106.

In an eighth embodiment of an induction heating apparatus 108 in accordance with the invention (FIG. 10B) comprising a vacuum hood 718, provision is made for the connecting device to comprise at least one pair of permanent magnets 110a, 110b via which an additional layer 204 can be releasably connected to the top side 48 of the vacuum hood 718.

The pair of permanent magnets comprises a first permanent magnet 110a and a second permanent magnet 110b which has the opposite pole. Therefore, the permanent magnets 110a, 110b are attracted to one another.

The first permanent magnet 110a is arranged at the top side 48 and is fixedly connected to the top side 48. It can additionally be embedded at least partially in the structural material 17 of the vacuum hood 718.

The additional layer 204 comprises the second permanent magnet 110b, which is fixedly connected to the additional layer 204. It can additionally be embedded at least partially in the structural material 17 of the vacuum hood 718. In particular, the second permanent magnet 110b is arranged at an outer side of the additional layer 204. The second permanent magnet 110b is in particular arranged such that it can be brought closer to the first permanent magnet 110a at the top side 48 of the vacuum hood 718 so that a sufficiently strong attraction is produced between the permanent magnets 110a, 110b in order to releasably connect the additional layer 204 to the top side 48.

In this way, a releasable connection can be established by magnetic forces between the additional layer 204 and the top side 48 of the vacuum hood 718.

Provision may be made for a releasable connection between the additional layer 204 and the top side 48 to be established by way of a plurality of pairs of permanent magnets 110a, 110b.

In a ninth embodiment of an induction heating apparatus 112 in accordance with the invention (FIG. 10C) comprising a vacuum hood 818, at least one first permanent magnet 110a is arranged at the underside 50 of the vacuum hood 818 and is fixedly connected to the underside 50. It can additionally be embedded at least partially in the structural material 17 of the vacuum hood 818.

In this way, a releasable connection can be established between the additional layer 204 and the underside 50 of the vacuum hood 818 analogously to what has been described for the previous embodiment.

Provision may be made for a plurality of additional layers 104, 204 to be connected to the vacuum hood 618, 718, 818 by way of connecting elements 102, 106 and/or pairs of permanent magnets 110a, 110b.

The features of the embodiments 1 to 9 described in the foregoing can be used both alone and in any combination with each other.

In accordance with the invention, an induction heating apparatus having a coil device 14 is provided, in which induction heating apparatus a homogeneous magnetic field distribution can be provided because of the avoidance of mutually cancelling fields. Homogeneous heating of a susceptor 66 can thereby be achieved.

A constant distance between the coil device 14 and the workpiece 52 can be established by vacuum application. Because the induction heating apparatus 10 is of flexurally flexible configuration, such homogeneous heating can also be achieved on workpieces 52 having a curved side 60.

In principle, the “heating surface” of the coil device 14 can be arbitrarily extended or a size adjustment can be made. To this end, the size of the spiral-shaped windings can be adjusted. Furthermore, the number of rows 34 and the number of columns 36 can be varied. This provides a simple way of producing induction heating apparatuses having “heating surfaces” of differing dimensions.

The “heating surface” can also be varied by arranging a plurality of coil layers 12 one next to the other within the vacuum hood 18. Optionally, different coil layers 12 can be controlled separately from each other. In this way, different zones of one or more susceptors 66 can be heated selectively.

In particular, it is possible to apply a vacuum between the underside 50 of the vacuum hood 18 and the side 60 of the workpiece 52 even if the underside 50 has only partial contact with the side 60. This situation occurs, for example, when the vacuum hood 18 is urged away from the side 60 of the workpiece 52 by a susceptor 66 arranged at the underside 50. It is possible to apply a negative pressure in the resulting cavity between the side 60 and the underside 50 provided that edge areas exist in concentric relation to the centre of the vacuum hood 18, which edge areas are located in surrounding relation to the repair region 62 and in which edge areas the underside 50 contacts the side 60 in gas-tight relation.

In accordance with the invention, a vacuum hood apparatus is provided which comprises an induction heating apparatus. The induction heating apparatus is integrated in the vacuum hood apparatus.

For carrying out a repair method using the induction heating apparatus 10 in accordance with the invention, the workpiece 52 is first provided with the repair patch 64 in the repair region 62. The repair patch 64 contains a repair material which can become substance to substance bonded to the material of the workpiece 52 by heating. The damaged structure in the repair region 62 of the workpiece 52 can thereby be restored.

In a next step, the susceptor 66 is arranged above the repair region 62 on the side 60. The vacuum hood 18 is placed with its underside 50 over the susceptor 66 so that the coil layer 12 is located above the susceptor 66. The boundaries of the underside 50 protrude beyond the boundaries of the susceptor 66.

Next, the port 58 is connected to a pump for drawing a vacuum. Once the pump is turned on, air is pumped out of the interspace between the side 60 and the underside 50. A negative pressure region is thereby created between the side 60 and the underside 50.

By the high-frequency source device 24, a high-frequency electromagnetic alternating field is created which is applied to the high-frequency Litz wire 20. The homogeneous magnetic alternating fields thereby produced induce electric currents in the susceptor 66, whereby the susceptor 66 is heated. The susceptor 66 in turn heats the repair region 62 or the repair patch 64 located below the susceptor 66. By heating the repair material of the repair patch 64, the defective area of the workpiece 52 is repaired as has been described hereinabove.

During the repair procedure, the temperature of the susceptor 66 can be controlled by the intensity of current that is applied to the high-frequency Litz wire 20 via the high-frequency source device 24.

After completion of the repair process, the electromagnetic alternating field and the negative pressure application can be deactivated. Following this, the vacuum hood 18 and the susceptor 66 can be removed from the workpiece 52.

An embodiment of the vacuum hood 118 comprises the reinforcing structure 70. The dimensional stability of the vacuum hood 118 is thereby increased. In this way, the formation of wrinkles or ripples on the top side 48 and the underside 50 of the vacuum hood 118 can be prevented when the vacuum hood 118 is placed upon the side 60 of the workpiece 52.

An embodiment of the vacuum hood 218 comprises a channel structure 74 at the underside 50. This allows air to be pumped out of the interspace between the side 60 and the underside 50 at a faster rate, whereby the application of negative pressure can be performed more effectively.

An embodiment of the vacuum hood 318 comprises the thermal insulation layer 80. This leads to reduced emission of heat radiation via the top side 48 during the heating process. This allows the susceptor 66 to be heated more efficiently because less heat radiation can be emitted from the top side 48. The susceptor 66 can thereby be heated to higher temperatures for the same current intensity applied to the high-frequency Litz wire 20. Furthermore, the homogeneity of the temperature distribution at the underside 50 can be enhanced.

In an embodiment, the vacuum hood 418 comprises at least one sensor 84 which is arranged at the underside 50 of the vacuum hood 418 and with which measured values can be sensed at the underside 50 during the repair process.

By way of example, it is thereby possible for the pressure and/or the temperature at the repair patch 64 or at the susceptor 66 to be controlled during the repair process by use of a suitable control device.

An embodiment of the vacuum hood 518 comprises a fixing device having an opening 90. At the opening 90, the vacuum hood 518 can be fixed in place at an intended location. By way of example, a hook or a rope can be passed through the opening 90. This can provide facilitated placement of the vacuum hood 518 in contact against the side 60 of the workpiece 52. This has particular application when the vacuum hood 518 needs to be placed in contact against the side 60 of the workpiece 52 when in vertical orientation to the floor. It is thereby possible to prevent the vacuum hood 518 from slipping off the side 60 of the workpiece 52 before the application of negative pressure application is activated.

In an embodiment of the vacuum hood 618, 718, 818, at least one additional layer 104, 204 can be releasably connected to the vacuum hood 618, 718, 818. By way of example, the additional layer 104, 204 can be the thermal insulation layer 80, the reinforcing structure 70 or a flow aid for a resin material. The vacuum hood 618, 718, 818 can thereby flexibly and easily be extended or reduced by adding or removing parts of it respectively. The configuration of the vacuum hood 618, 718, 818 can be flexibly adapted to suit the needs of the particular repair process.

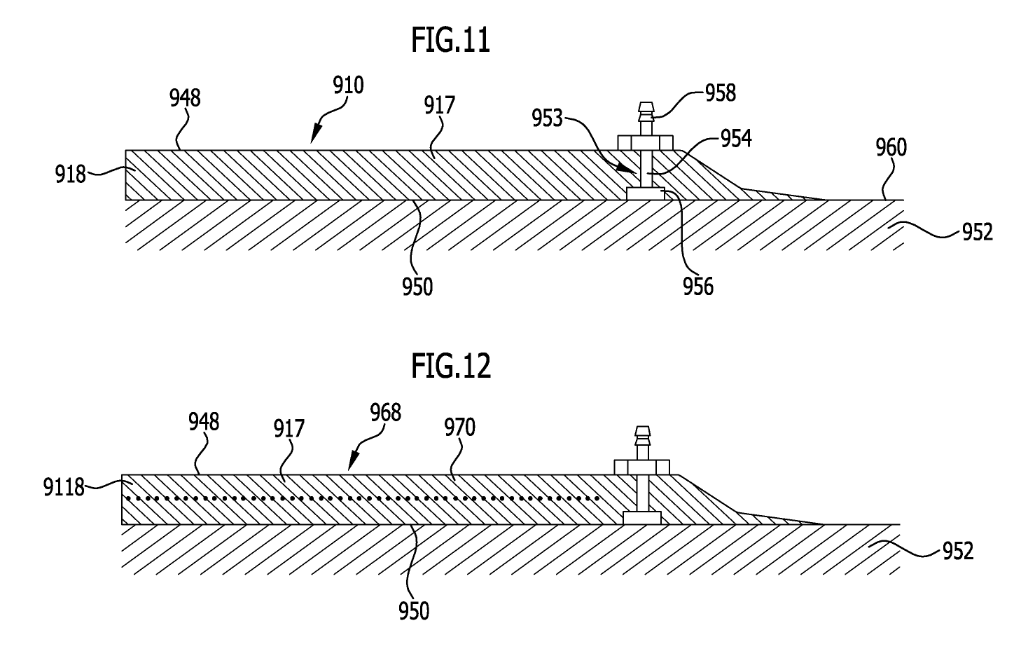

A first exemplary embodiment of a vacuum hood apparatus in accordance with the invention which is schematically shown in FIG. 11 and designated therein by 910, comprises a vacuum hood 918.

In particular, the vacuum hood 918 is made of a structural material 917 which is flexurally flexible and gas-tight. The structural material 917 of the vacuum hood 918 is a silicone material for example.

The precursor material of the vacuum hood 918 is in particular castable and injection mouldable. It is thereby possible for the vacuum hood 918 to be produced by injection moulding.

The vacuum hood 918 has a top side 948 and an underside 950. In operation of the vacuum hood apparatus 910, the underside 950 faces towards a workpiece 952 and the top side 948 faces away from the workpiece 952.

The vacuum hood 918 comprises a channel device 953 having at least one feed channel 954 which extends from the top side 948 to the underside 950.

The feed channel 954 runs transversely relative to the top side 948 and the underside 950.

At the underside 950, the feed channel 954 opens into a distributor 956. Connected to the distributor 956 are one or more channels of the channel device 953, in particular wherein the channels run at the underside 950 and/or are open towards the underside 950.

Arranged at the mouth of the feed channel 954 opening towards the top side 948 is a port 958. Provision is made for the port 958 to be operatively connected for fluid communication with a device for applying a vacuum, such as a pump. In this manner, a negative pressure region can be created between a side 960 of the workpiece 952 and the underside 950 which is at least partially in contact with the side 960.

In operation of the induction heating apparatus 910, a negative pressure region is created between the side 960 of the workpiece 952 and the underside 950 of the vacuum hood 918 by the application of vacuum. By virtue of the negative pressure region, the vacuum hood 918 is urged against the side 960 of the workpiece 952. An approximately constant distance is thereby established between the vacuum hood 918 and the side 960.

In the embodiments of a vacuum hood apparatus in accordance with the invention as described in the following, the same reference characters are used to denote components that are identical to those of the vacuum hood apparatus 910 illustrated in the first embodiment. What has been described regarding these components of the first embodiment also applies to the other embodiments.

In a second embodiment of a vacuum hood apparatus 968 in accordance with the invention (FIG. 12) comprising a vacuum hood 9118, the vacuum hood 9118 comprises a reinforcing structure 970 which is embedded in the structural material 917 of the vacuum hood 9118. The reinforcing structure 970 is made of an electrical insulator material. It is in particular of flexurally flexible configuration. The reinforcing structure 970 is in particular a textile structure, such as a woven or knitted fabric.

In particular, the reinforcing structure 970 is located between the underside 950 and the top side 948 of the vacuum hood 9118. The reinforcing structure 970 is in particular of sheet-like configuration.

By the use of the reinforcing structure 970, the dimensional stability of the vacuum hood 9118 can be increased. In this way, undesired deformations of the vacuum hood 9118, such as deformations caused by wrinkling, can largely be avoided when operating the vacuum hood apparatus 968.

In a third embodiment of a vacuum hood apparatus 972 in accordance with the invention (FIG. 13) comprising a vacuum hood 9218, the channel device 953 comprises, at the underside 950 of the vacuum hood 9218, a channel structure 974 having at least one channel. The channel structure 974 is arranged at the underside 950.

In operation of the vacuum hood apparatus 972, the channels of the channel structure 974 are, at an opening thereof, open to the side 960 of the workpiece 952.

The underside 950 of the vacuum hood 9218 has wall elements 976 which form projections at the underside 950 and which, in operation of the vacuum hood apparatus 972, are at least partially in contact against the side 960 of the workpiece 952. The wall elements 976 form the walls of the channel structure 974. The channel structure 974 is formed in the interspaces between between the wall elements 976.

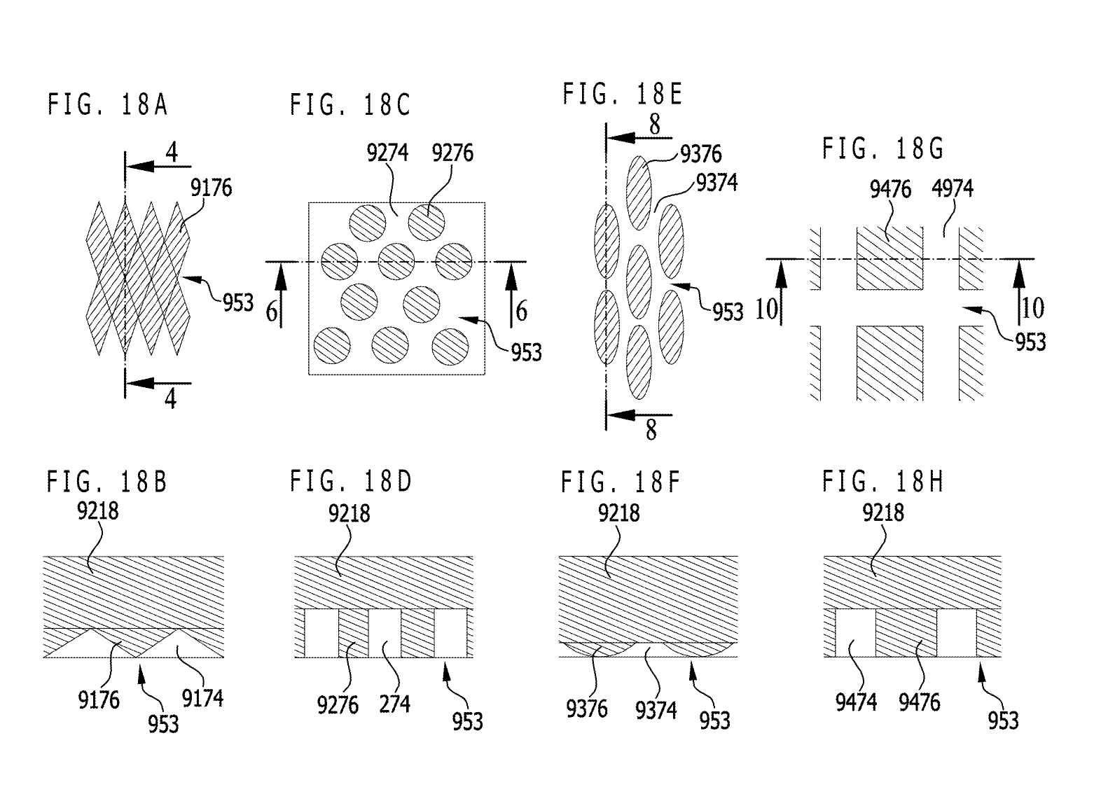

The wall elements 976 can present different geometric configurations. By way of example, the wall elements 9176 are pyramids, the wall elements 9276 are cylinders, the wall elements 9376 are semi-ellipsoids and the wall elements 9476 are cuboids. They present different cross-sectional shapes when viewed perpendicularly relative to the underside 950 of the vacuum hood 9218. The wall elements 9176 (FIG. 18A) have a rhombic cross-sectional shape, the wall elements 9276 (FIG. 18C) have a circular cross-sectional shape, the wall elements 9376 (FIG. 18E) have an elliptical cross-sectional shape and the wall elements 9476 (FIG. 18G) have a rectangular cross-sectional shape. The channel structures 9174, 9274, 9374, 9474 are formed in the interspaces between the wall elements 9176, 9276, 9376, 9476 in each case. The vertical cross-sectional shapes in a section taken perpendicularly to the underside 950 of the vacuum hood 9218 are triangles for the wall elements 9176 (FIG. 18B), squares for the wall elements 9276 (FIG. 18D), semi-ellipses for the wall elements 9476 (FIG. 18F) and rectangles for the wall elements 9476 (FIG. 18H).

By way of example, the wall elements 976, or the channel structure 974, are or is fabricated by removing material from the vacuum hood 9218 in the interspaces between the wall elements 976.

The channel structure 974 can also be produced by an injection moulding process using a suitable mould. To this end, the mould has recesses conforming to the geometry of the wall elements 976. The recesses are filled with the precursor material of the vacuum hood 9218 during the injection moulding process. The material present in the recesses of the mould later forms the wall elements 976 in the form of projections at the underside 950 of the vacuum hood 9218.

In particular, the channel structure 974 is connected to the distributor 956 of the feed channel 954 for applying a vacuum. The negative pressure can thereby be applied over a large area at the underside 950. In this manner, the application of negative pressure can be performed more effectively and the negative pressure region between the underside 950 of the vacuum hood 918 and the side 960 of the workpiece 952 can be enhanced.

Alternatively or in addition, the channel structure 974 can be utilized to supply to the workpiece 952 an infiltration material, such as a resin, when the vacuum hood apparatus 972 is operated.

In particular, a sum of cross-sectional areas of the openings of the channels of the channel structure 974 at the underside 950 is at least 30% of the total area of the underside 950. The negative pressure can thereby be applied over a large area at the underside 950.

In particular, the sum of the cross-sectional areas of the openings of the channels of the channel structure 974 at the underside 950 is at least 40%, at least 50%, at least 60%, at least 70%, at least 80% or at least 90% of the total area of the underside.

In particular, the channels of the channel structure 974 are arranged uniformly over the underside 950. Provision is made that a uniform arrangement of the channels of the channel structure 974 is implemented in that in a portion of area of the underside 950 that encompasses 25% of the total area of the underside 950, the sum of the cross-sectional areas of the openings of the channels of the channel structure 974 that lie within said portion of area is at least 10% and at most 40% of the sum of the cross-sectional areas of the openings of all channels of the channel structure 974.

In particular, the sum of the cross-sectional areas of the openings of the channels of channel structure 974 that lie within said portion of area, is in particular at least 15% or at least 20% of the sum of the cross-sectional areas of the openings of all channels of the channel structure 974.

In particular, the sum of the cross-sectional areas of the openings of the channels of channel structure 974 that lie within said portion of area is at most 30% or at most 35% of the sum of the cross-sectional areas of the openings of all channels of the channel structure 974.

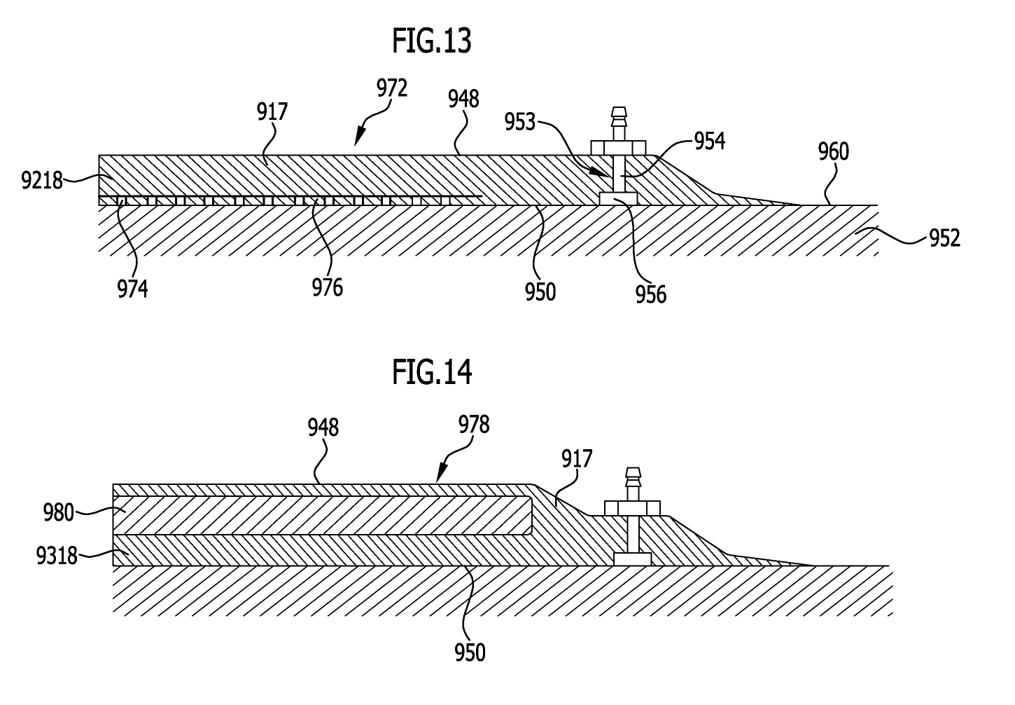

In a fourth embodiment of a vacuum hood apparatus 978 in accordance with the invention (FIG. 14) comprising a vacuum hood 9318, the vacuum hood 9318 comprises a thermal insulation layer 980 which is embedded in the structural material 917 of the vacuum hood 9318. The thermal insulation layer 80 is in particular arranged between the underside 950 and the top side 948.

In particular, the thermal insulation layer 980 is of sheet-like configuration.

The material of the thermal insulation layer 980 has a thermal conductivity lower than that of the structural material 917 of the vacuum hood 9318. The thermal insulation layer 980 is made, for example, of a heat-insulating plastics material, such as polystyrene.

By the use of the thermal insulation layer 980, the emission of heat radiation via the top side 948 of the vacuum hood 9318 can be avoided or at least reduced when the vacuum hood apparatus 978 is operated.

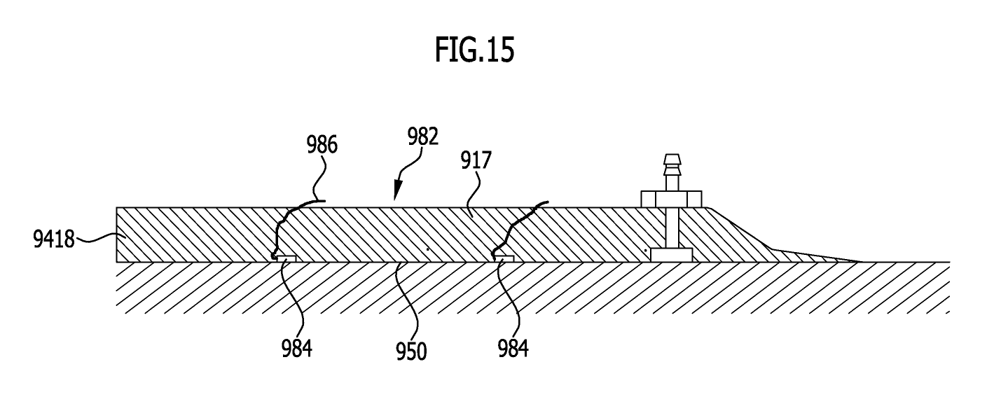

In a fifth embodiment of a vacuum hood apparatus 982 in accordance with the invention (FIG. 15) comprising a vacuum hood 9418, the vacuum hood 9418 comprises at least one sensor 984 which is arranged at the underside 950. The sensor 984 can be at least partially embedded in the material of the vacuum hood 9418. The sensor 984 has a supply line 986 which is operatively connected to the sensor 984 for electrical communication therewith and is routed through the material of the vacuum hood 9418 to the outside.

The sensor 984 is, for example, a temperature sensor or a pressure sensor.

The use of the sensor 984 allows measured values to be sensed at the underside 950 of the vacuum hood 9418 when the vacuum hood apparatus 982 is operated. These measured values can be used, for example, to control parameters such as pressure and/or temperature.

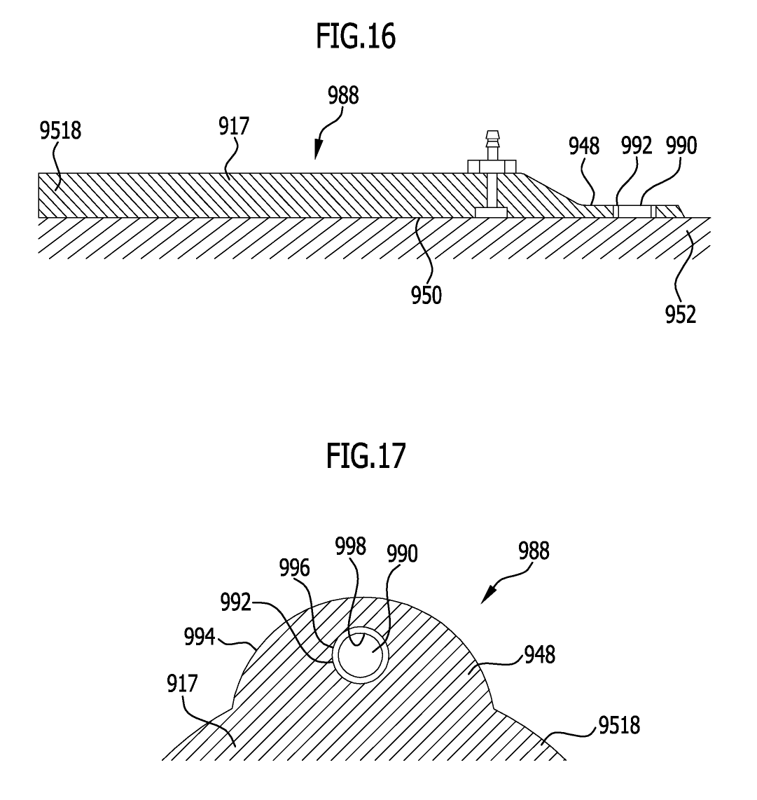

In a sixth embodiment of a vacuum hood apparatus 988 in accordance with the invention (FIG. 16 and FIG. 17) comprising a vacuum hood 9518, the vacuum hood 9518 comprises a fixing device having a lug and an opening 990. The boundary of the opening 990 has an edge element 992.

In particular, the lug is connected in one piece to the vacuum hood 9518. By way of example, the lug and the vacuum hood 9518 are made of the same structural material 917. An integral component part consisting of vacuum hood 9518 and lug can thereby be produced in a single work step and using injection moulding techniques.

The opening 990 is preferably arranged close to an outer boundary 994 of the vacuum hood 9518. It extends from the top side 948 to the underside 950.

The edge element 992 has an inner side 996 facing towards the opening 990 and an outer side 998 facing towards the structural material 917 of the vacuum hood 9518. The outer side 998 contacts the structural material 917 of the vacuum hood 9518. Alternatively or in addition, the edge element 992 can be embedded at least partially in the structural material 917 of the vacuum hood 9518.

Provision is made for the vacuum hood 9518 having the opening 990 to be fastened to an external fastening device and/or to the workpiece 952. In particular, the external fastening device is passed through the opening 990 of the vacuum hood 9518. It contacts the inner side 996 of the edge element 992 at least partially. Forces can thereby be exerted on the vacuum hood 9518, whereby the vacuum hood 9518 can be fixed at a position.

By way of example, the external fastening device can be a hook or a rope which is passed through the opening 990.

In this way, it is for example possible for the vacuum hood apparatus 988 to be fixed and brought in contact against a workpiece 952 in vertical relation to the floor surface before the application of vacuum is activated.

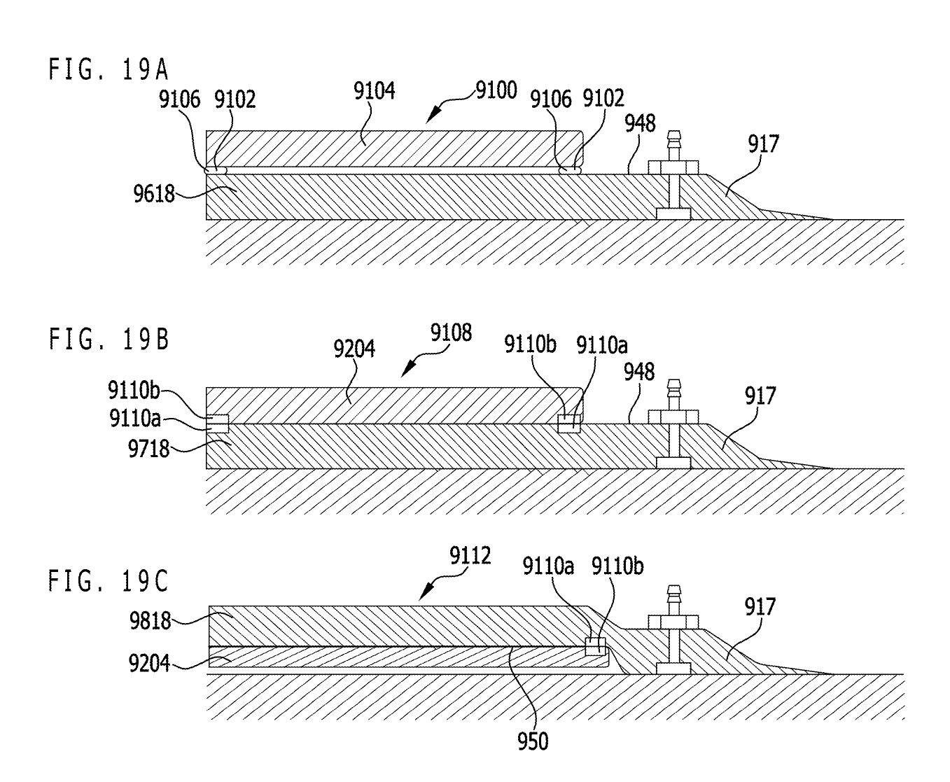

In a seventh embodiment of a vacuum hood apparatus 9100 in accordance with the invention (FIG. 19A) comprising a vacuum hood 9618, provision is made for at least one additional layer 9104 to be releasably connectable to the top side 948 of the vacuum hood 9618 via a connecting device having at least one connecting element 9102.

By way of example, the additional layer 9104 can be the thermal insulation layer 980, the reinforcing structure 970 or a flow aid for a resin material.

The connecting element 9102 is arranged at the top side 948 of the vacuum hood 9618 and is fixedly connected to the top side 948. By way of example, the connecting element 9102 is substance to substance bonded to the top side 948 using an adhesive material.

The additional layer 9104 in turn likewise comprises a connecting element 9106 which is fixedly connected thereto and is releasably connectable to the connecting element 9102 of the vacuum hood 9618.

In particular, the connecting element 9102 represents a counterpart to the connecting element 9106. By way of example, the connecting elements 9102, 9106 are configured as a hook-and-loop connection. In this case, the connecting element 9102 represents the counterpart of a hook-and-loop fastener to that of the connecting element 9106. The connecting elements 9102, 9106 can alternatively be configured as a snap fastener type connection. The connecting element 9102 in this case comprises a stud and the connecting element 9106 comprises its counterpart (or vice versa).

Provision may be made for a releasable connection between the additional layer 9104 and the top side 948 to be made via a plurality of connecting elements 104, 106.

In particular, the additional layer 9104 is of flexurally flexible configuration.

In an eighth embodiment of a vacuum hood apparatus 9108 in accordance with the invention (FIG. 19B) comprising a vacuum hood 9718, provision is made for the connecting device to comprise at least one pair of permanent magnets 9110a, 9110b via which an additional layer 9204 can be releasably connected to the top side 948 of the vacuum hood 9718.

The pair of permanent magnets comprises a first permanent magnet 9110a and a second permanent magnet 9110b which has the opposite pole. Therefore, the permanent magnets 9110a, 9110b are attracted to one another.

The first permanent magnet 9110a is arranged at the top side 948 and is fixedly connected to the top side 948. It can additionally be embedded at least partially in the structural material 917 of the vacuum hood 9718.

The additional layer 9204 comprises the second permanent magnet 9110b, which is fixedly connected to the additional layer 9204. It can additionally be embedded at least partially in the material of the additional layer 9204. In particular, the second permanent magnet 9110b is arranged at an outer side of the additional layer 9204. The second permanent magnet 9110b is in particular arranged such that it can be brought closer to the first permanent magnet 9110a at the top side 948 of the vacuum hood apparatus 9718 so that a sufficiently strong attraction is produced between the permanent magnets 9110a, 9110b in order to releasably connect the additional layer 9204 to the top side 948.

In this way, a releasable connection can be established by magnetic forces between the additional layer 9204 and the top side 948 of the vacuum hood 9718.

Provision may be made for a releasable connection between the additional layer 9204 and the top side 948 to be established by way of a plurality of pairs of permanent magnets 9110a, 9110b.

In a ninth embodiment of a vacuum hood apparatus 9112 in accordance with the invention (FIG. 19C) comprising a vacuum hood 9818, at least one first permanent magnet 9110a is arranged at the underside 950 of the vacuum hood 9818 and is fixedly connected to the underside 950. It can additionally be embedded at least partially in the structural material 917 of the vacuum hood 9818.

In this way a releasable connection can be established between the additional layer 9204 and the underside 950 of the vacuum hood 9818 analogously to what has been described for the previous embodiment.

Provision may be made for a plurality of additional layers 9104, 9204 to be connected to the vacuum hood 9618, 9718, 9818 by way of connecting elements 9102, 9106 and/or pairs of permanent magnets 9110a, 9110b.

The features of the embodiments 1 to 9 described above can be used both alone and in any combination with each other.

In accordance with the invention, a vacuum hood apparatus 910 comprising a vacuum hood 918 is provided, in which vacuum hood apparatus 910 a constant distance between the vacuum hood 918 and the workpiece 952 can be established by vacuum application. Because the vacuum hood apparatus 910 is of flexurally flexible configuration, the vacuum hood apparatus 910 can also be used on workpieces 952 having a curved side 960.

By way of example, the vacuum hood apparatus 910 can be used for implementing a repair method on a workpiece 952. The workpiece 952 is for example a damaged fibre composite material component part having a repair region. The repair method can be carried out analogously to what has been described for the repair method in connection with the induction heating apparatus 10, wherein the repair region is heated via an external heating device.

In particular, it is possible to apply a vacuum between the underside 950 of the vacuum hood 918 and the side 960 of the workpiece 952 even if the underside 950 has only partial contact with the side 960. This situation occurs, for example, when the vacuum hood 918 is urged away from the side 960 of the workpiece 952 by an object arranged between the underside 950 and the side 960. It is possible to apply a negative pressure in the resulting cavity between the side 960 and the underside 950 provided that edge areas exist in concentric relation to the centre of the vacuum hood 918, in which edge areas the underside 950 contacts the side 960 in gas-tight relation.

An embodiment of the vacuum hood 9118 comprises the reinforcing structure 970. The dimensional stability of the vacuum hood 9118 is thereby increased. In this way, the formation of wrinkles or ripples on the top side 948 and the underside 950 of the vacuum hood 9118 can be prevented when the vacuum hood 9118 is placed upon the side 960 of the workpiece 952.

An embodiment of the vacuum hood 9218 comprises a channel structure 974 at the underside 950. This allows air to be pumped out of the interspace between the side 960 and the underside 950 at a faster rate, whereby the application of negative pressure can be performed more effectively.

An embodiment of the vacuum hood 9318 comprises the thermal insulation layer 980. This leads to reduced emission of heat radiation via the top side 948. By way of example, this allows the emission of heat radiation from a hot repair material at the underside 950 of the vacuum hood 9318 to be reduced because less heat radiation can be emitted via the top side 948. The homogeneity of the temperature distribution at the underside 950 can thereby be enhanced.

In an embodiment, the vacuum hood 9418 comprises at least one sensor 984 which is arranged at the underside 950 of the vacuum hood 9418 and with which measured values can be sensed at the underside 950 during operation of the vacuum hood apparatus. By way of example, it is thereby possible for the pressure and/or the temperature at the workpiece 952 to be controlled during operation of the induction heating apparatus 982 by use of a suitable control device.

An embodiment of the vacuum hood 9518 comprises a fixing device having an opening 990. At the opening 990, the vacuum hood 9518 can be fixed in place at an intended location. By way of example, a hook or a rope can be passed through the opening 990. This can provide facilitated placement of the vacuum hood 9518 in contact against the side 960 of the workpiece 952. This has particular application when the vacuum hood 9518 needs to be placed in contact against the side 960 of the workpiece 952 when in vertical orientation relative to the floor. It is thereby possible to prevent the vacuum hood 9518 from slipping off the side 960 of the workpiece 952 before the application of negative pressure is activated.

In an embodiment of the vacuum hood 9618, 9718, 9818, at least one additional layer 9104, 9204 can be releasably connected to the vacuum hood 9618, 9718, 9818. By way of example, the additional layer 9104, 9204 can be the thermal insulation layer 980, the reinforcing structure 970 or a flow aid for a resin material. The vacuum hood 9618, 9718, 9818 can thereby flexibly and easily be extended or reduced by adding or removing parts of it respectively. The configuration of the vacuum hood 9618, 9718, 9818 can be flexibly adapted to suit the particular needs.

### LIST OF REFERENCE CHARACTERS

10 induction heating apparatus
12 coil layer
14 coil device
16 carrier
17 structural material
18 vacuum hood
20 high-frequency Litz wire
22 sheath
24 high-frequency source device
26a terminal
26b terminal
28 terminal
30 terminal
32 spiral-shaped windings
34 rows
36 columns
38 turns
40 starting point
42a spiral-shaped winding
42b spiral-shaped winding
44a spiral-shaped winding
44b spiral-shaped winding
46 first side
48 top side
50 underside
52 workpiece
53 channel device
54 feed channel
56 distributor
58 port
60 side
62 repair region
64 repair patch
66 susceptor
68 induction heating apparatus
70 reinforcing structure
72 induction heating apparatus
74 channel structure
76 wall element
78 induction heating apparatus
80 thermal insulation layer
82 induction heating apparatus
84 sensor
86 supply line
88 induction heating apparatus
90 opening
92 edge element
94 boundary
96 inner side
98 outer side
100 induction heating apparatus
102 connecting element
104 additional layer
106 connecting element
108 induction heating apparatus
110a first permanent magnet
110b second permanent magnet
112 induction heating apparatus
118 vacuum hood
174 channel structure
176 wall element
204 additional layer
218 vacuum hood
274 channel structure
276 wall element
318 vacuum hood
374 channel structure
376 wall element
418 vacuum hood
474 channel structure
476 wall element
518 vacuum hood
618 vacuum hood
718 vacuum hood
818 vacuum hood
910 vacuum hood apparatus
917 structural material
918 vacuum hood
948 top side
950 underside
952 workpiece
953 channel device
954 feed channel
956 distributor
958 port
960 side
968 vacuum hood apparatus
970 reinforcing structure
972 vacuum hood apparatus
974 channel structure
976 wall element
978 vacuum hood apparatus
980 thermal insulation layer
982 vacuum hood apparatus
984 sensor
986 supply line
988 vacuum hood apparatus
990 opening
992 edge element
994 boundary
996 inner side
998 outer side
9100 vacuum hood apparatus
9102 connecting element
9104 additional layer
9106 connecting element
9108 induction heating apparatus
9110a first permanent magnet
9110b second permanent magnet
9112 vacuum hood apparatus
9118 vacuum hood
9174 channel structure
9176 wall element
9204 additional layer
9218 vacuum hood
9274 channel structure
9276 wall element
9318 vacuum hood
9374 channel structure
9376 wall element
9418 vacuum hood
9474 channel structure
9476 wall element
9518 vacuum hood
9618 vacuum hood
9718 vacuum hood
9818 vacuum hood

What is claimed is:

1. Induction heating apparatus, comprising:
at least one coil layer having a coil device and a carrier, on which carrier the coil device is arranged;
wherein the at least one coil layer is of flexurally flexible configuration;
wherein the at least one coil layer is embedded in the structural material of a vacuum hood; and
wherein the vacuum hood having the at least one coil layer is of flexurally flexible configuration.

2. Induction heating apparatus in accordance with claim 1, wherein the at least one coil layer is surrounded by the structural material of the vacuum hood.

3. Induction heating apparatus in accordance with claim 1, wherein the coil device comprises a plurality of spiral-shaped windings, wherein the spiral-shaped windings are arranged in at least one of rows and columns.

4. Induction heating apparatus in accordance with claim 1, wherein the carrier is formed by at least one of a fibre structure and a mesh structure, wherein the coil device is held to the carrier via one or more holding threads.

5. Induction heating apparatus in accordance with claim 1, wherein the vacuum hood has an underside which, in operation of the vacuum hood apparatus, faces towards a workpiece, wherein the vacuum hood comprises a channel device comprising at least one feed channel and wherein, by applying a negative pressure to the at least one feed channel, at least one of (i) a negative pressure region is creatable between the underside and the workpiece and (ii) the workpiece is infiltratable with a material via the at least one feed channel.

6. Induction heating apparatus in accordance with claim 5, wherein the vacuum hood comprises at least one port which is operatively connected to the at least one feed channel for fluid communication therewith.

7. Induction heating apparatus in accordance with claim 5, wherein the vacuum hood comprises at least one distributor.

8. Induction heating apparatus in accordance with claim 5, wherein the channel device comprises a channel structure having at least one channel at the underside of the vacuum hood, which channel is, at an opening thereof, open towards the underside.

9. Induction heating apparatus in accordance with claim 8, wherein a sum of cross-sectional areas of the openings of all channels of the channel structure at the underside is at least 30% of the total area of the underside.

10. Induction heating apparatus in accordance with claim 8, wherein the channels of the channel structure are arranged uniformly across the underside.

11. Induction heating apparatus in accordance with claim 1, wherein the vacuum hood comprises a reinforcing structure which is embedded in the structural material of the vacuum hood.

12. Induction heating apparatus in accordance with claim 1, wherein the vacuum hood comprises at least one thermal insulation layer which is embedded in the structural material of the vacuum hood.

13. Induction heating apparatus in accordance with claim 1, wherein the vacuum hood has at least one sensor associated therewith.

14. Induction heating apparatus in accordance with claim 1, wherein the vacuum hood comprises a fixing device having at least one lug and at least one opening.

15. Induction heating apparatus in accordance with claim 14, wherein the at least one lug is connected in one piece to the vacuum hood.

16. Induction heating apparatus in accordance with claim 1, wherein the vacuum hood is made of at least one of a castable structural material and an injection mouldable structural material.

17. Induction heating apparatus in accordance with claim 1, wherein the structural material of the vacuum hood is a silicone material.

18. Induction heating apparatus in accordance with claim 1, wherein at least one additional layer is provided which is releasably connected to the vacuum hood via a connecting device.

19. Induction heating apparatus in accordance with claim 18, wherein the connecting device comprises at least one of (i) at least one magnet and (ii) at least one hook-and-loop connection.

20. Repair method using an induction heating apparatus, the induction heating apparatus comprising:
at least one coil layer having a coil device and a carrier, on which carrier the coil device is arranged;
wherein the at least one coil layer is of flexurally flexible configuration;
wherein the at least one coil layer is embedded in the structural material of a vacuum hood; and
wherein the vacuum hood having the at least one coil layer is of flexurally flexible configuration;
said repair method comprising:
applying the induction heating apparatus to a repair region of a workpiece;
creating a negative pressure region between the workpiece and the vacuum hood; and
heating a material in the repair region, wherein the heating of the material is realized via a susceptor arranged in the repair region, which susceptor is inductively heated by way of the induction heating apparatus.

21. Repair method in accordance with claim 20, wherein in operation of the induction heating apparatus, the material is supplied to the repair region via at least one feed channel of the vacuum hood.

22. Vacuum hood apparatus, comprising:
a vacuum hood;
wherein the vacuum hood has an underside which, in operation of the vacuum hood apparatus, faces towards a workpiece;
wherein the vacuum hood comprises a channel device comprising at least one feed channel and a channel structure having at least one channel at the underside;
and wherein the at least one channel of the channel structure is, at an opening thereof, open towards the underside and is operatively connected to the at least one feed channel for fluid communication therewith;
wherein a sum of cross-sectional areas of the openings of all channels of the channel structure at the underside is at least 30% of the total area of the underside.

23. Vacuum hood apparatus in accordance with claim 22, wherein the channels of the channel structure are arranged uniformly across the underside and in particular wherein, in a portion of area of the underside.

24. Vacuum hood apparatus in accordance with claim 1, wherein, by applying a negative pressure to the at least one feed channel, at least one of (i) a negative pressure region is creatable between the underside and the workpiece and (ii) the workpiece is infiltratable with a material via the at least one feed channel.

25. Vacuum hood apparatus in accordance with claim 1, wherein the vacuum hood comprises at least one port which is operatively connected to the at least one feed channel for fluid communication therewith.

26. Vacuum hood apparatus in accordance with claim 1, wherein the vacuum hood comprises at least one distributor.

27. Vacuum hood apparatus in accordance with claim 1, wherein the vacuum hood comprises a reinforcing structure which is embedded in the structural material of the vacuum hood.

28. Vacuum hood apparatus in accordance with claim 1, wherein the vacuum hood comprises at least one thermal insulation layer which is embedded in the structural material of the vacuum hood.

29. Vacuum hood apparatus in accordance with claim 1, wherein the vacuum hood has at least one sensor associated therewith.

30. Vacuum hood apparatus in accordance with claim 1, wherein the vacuum hood comprises a fixing device having at least one lug and at least one opening.

31. Vacuum hood apparatus in accordance with claim 30, wherein the at least one lug is connected in one piece to the vacuum hood.

32. Vacuum hood apparatus in accordance with claim 1, wherein the vacuum hood is made of at least one of a castable structural material and an injection mouldable structural material.

33. Vacuum hood apparatus in accordance with claim 1, wherein the structural material of the vacuum hood is a silicone material.

34. Vacuum hood apparatus in accordance with claim 1, wherein at least one additional layer is provided which is releasably connected to the vacuum hood via a connecting device.

35. Vacuum hood apparatus in accordance with claim 34, wherein the connecting device comprises at least one of (i) at least one magnet and (ii) at least one hook-and-loop connection.
